(19) United States
(12) Patent Application Publication
(10) Pub. No.: US 2007/0268376 A1
(43) Pub. Date: Nov. 22, 2007

(54) Imaging Apparatus and Imaging Method

(75) Inventors: Seiji Yoshikawa, Tokyo (JP); Yusuke Hayashi, Tokyo (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 11/574,127

(22) PCT Filed: Aug. 26, 2005
(86) PCT No.: PCT/JP05/15542

§ 371 Date: Feb. 22, 2007

(30) Foreign Application Priority Data
Aug. 26, 2004 (JP) 2004-247444
Aug. 26, 2004 (JP) 2004-247445
Aug. 26, 2004 (JP) 2004-247446
Aug. 26, 2004 (JP) 2004-247447
Jul. 27, 2005 (JP) 2005-217799
Jul. 27, 2005 (JP) 2005-217800
Jul. 27, 2005 (JP) 2005-217801
Jul. 27, 2005 (JP) 2005-217802

(51) Int. Cl. H04N 5/225

(52) U.S. Cl. 348/222.1; 348/135; 348/240.1

(57) ABSTRACT

An imaging apparatus, and method, enabling lens design without regard to an object distance and a defocus range and enabling image restoration by high precision processing, has an image lens device 200 for capturing a dispersed image of an object passing through an optical system and a phase plate serving as an optical wavefront modulation element, an image processing device 300 for generating a dispersion-free image signal from a dispersed image signal from the imaging element 220, and an object schematic distance information detection device 400 for generating information corresponding to the distance up to the object, wherein the image processing device 300 generates a dispersion-free image signal from the dispersed image signal based on the information generated by the object schematic distance information detection device 400.

### TECHNICAL FIELD

The present invention relates to a digital still camera, a camera mounted in a mobile phone, a camera mounted in a personal digital assistant, or another imaging apparatus using an imaging element and provided with an optical system and an optical wavefront modulation element (phase plate), an imaging method, and an image conversion method.

### BACKGROUND ART

In recent years, rapid advances have been made in digitalization of information. This has led to remarkable efforts to meet with this in the imaging field.

In particular, as symbolized by the digital camera, in the imaging surfaces, the conventional film is being taken over by use of solid-state imaging elements such as CCDs (Charge Coupled Devices) or CMOS (Complementary Metal Oxide Semiconductor) sensors in most cases.

An imaging lens device using a CCD or CMOS sensor for the imaging element in this way optically captures the image of an object by the optical system and extracts the image as an electric signal by the imaging element. Other than a digital still camera, this is used in a video camera, a digital video unit, a personal computer, a mobile phone, a personal digital assistant (PDA), and so on.

FIG. 1 is a diagram schematically showing the configuration of a general imaging lens device and a state of light beams.

This imaging lens device 1 has an optical system 2 and a CCD or CMOS sensor or other imaging element 3.

The optical system includes object side lenses 21 and 22, a stop 23, and an imaging lens 24 sequentially arranged from the object side (OBJS) toward the imaging element 3 side.

In the imaging lens device 1, as shown in FIG. 1, the best focus surface is made to match with the imaging element surface.

FIG. 2A to FIG. 2C show spot images on a light receiving surface of the imaging element 3 of the imaging lens device 1.

Further, imaging devices using phase plates (wavefront coding optical elements) to regularly disperse the light beams, using digital processing to restore the image, and thereby enabling capture of an image having a deep depth of field and so on have been proposed (see for example Non-patent Documents 1 and 2 and Patent Documents 1 to 5).

Non-patent Document 1: “Wavefront Coding; jointly optimized optical and digital imaging systems”, Edward R. Dowski, Jr., Robert H. Cormack, Scott D. Sarama.

Non-patent Document 2: “Wavefront Coding; A modern method of achieving high performance and/or low cost imaging systems”, Edward R. Dowski, Jr., Gregory E. Johnson.

Patent Document 1: U.S. Pat. No. 6,021,005

Patent Document 2: U.S. Pat. No. 6,642,504

Patent Document 3: U.S. Pat. No. 6,525,302

Patent Document 4: U.S. Pat. No. 6,069,738

Patent Document 5: Japanese Patent Publication (A) No. 2003-235794

### DISCLOSURE OF THE INVENTION

### Problem to be Solved by the Invention

All of the imaging apparatuses proposed in the documents explained above are predicated on a PSF (Point-Spread-Function) being constant when inserting the above phase plate in the usual optical system. If the PSF changes, it is extremely difficult to realize an image having a deep depth of field by convolution using the subsequent kernels.

Accordingly, even in the case of lenses with a single focal point, in the usual optical system changing in its spot image according to the object distance, a constant (not changing) PSF cannot be realized. In order to solve this, a high level of precision of the optical design of the lenses is required. The accompanying increase in costs causes a major problem in adoption of this.

In other words, in a general imaging apparatus, suitable convolution processing is not possible. An optical design eliminating the astigmatism, coma aberration, zoom chromatic aberration, and other aberration causing deviation of the spot image at the time of the “wide” mode and at the time of the “tele” mode is required.

However, optical design eliminating these aberrations increases the difficulty of the optical design and induces problems such as an increase of the number of design processes, an increase of the costs, and an increase in size of the lenses.

Further, as explained above, even in the case of lenses having a single focal point, in the usual optical system changing in its spot image according to the object distance, a constant (not changing) PSF cannot be realized. To solve this problem, it is necessary to design the optical system so that the spot image does not change due to a change of the object distance before the phase plate is inserted. This demands more difficult, precise design and also exerts an effect upon the cost of the optical system.

Accordingly, the WFCO involves problems of the design difficulty and precision and involves a big problem in the picture-making required for application to a digital camera or camcorder etc., that is, a so-called “natural image” where the object desired to be captured is in focus, but the background is blurred cannot be realized.

A first object of the present invention is to provide an imaging apparatus able to simplify the optical system, enabling cost reduction, enabling lens design without regard as to the object distance and defocus range, and enabling image restoration by a high precision processing and a method of the same.

A second object of the present invention is to provide an imaging apparatus able to give a high definition image quality and in addition able to simplify the optical system, enabling cost reduction, enabling lens design without regard as to the zoom position or zoom amount, and enabling image restoration by a high precision processing and a method of the same.

A third object of the present invention is to provide an imaging apparatus, an imaging method, and an image conversion method able to simplify the optical system, enabling cost reduction, enabling lens design without regard as to the object distance and defocus range, and enabling image restoration by a high precision processing and in addition able to obtain a natural image.

### Means for Solving the Problems

An imaging apparatus according to a first aspect of the present invention includes an imaging element for capturing a dispersed image of an object passing through at least an optical system and an optical wavefront modulation element, a converting means for generating a dispersion-free image signal from a dispersed image signal from the imaging element, and an object distance information generating means for generating information corresponding to a distance up to the object, wherein the converting means generates the dispersion-free image signal from the dispersed image signal based on the information generated by the object distance information generating means.

Preferably, the apparatus further includes a conversion coefficient storing means for storing in advance at least two conversion coefficients corresponding to the dispersion caused by at least the optical wavefront modulation element in accordance with the object distance and a coefficient selecting means for selecting a conversion coefficient in accordance with a distance up to the object from the conversion coefficient storing means based on the information generated by the object distance information generating means, wherein the converting means converts the image signal by the conversion coefficient selected by the coefficient selecting means.

Preferably, the apparatus further includes a conversion coefficient operation means for processing a conversion coefficient based on the information generated by the object distance information generating means, wherein the converting means converts the image signal according to the conversion coefficient obtained from the conversion coefficient operation means.

Preferably, the conversion coefficient operation means includes a kernel size as a variable.

Preferably, the apparatus has a storing means, the conversion coefficient operation means stores the found conversion coefficient in the storing means, and the converting means converts the image signal according to the conversion coefficient stored in the storing means to generate a dispersion-free image signal.

Preferably, the converting means performs convolution operation based on the conversion coefficient.

Preferably, the optical system includes a zoom optical system, the apparatus further has a correction value storing means for storing in advance at least one correction value in accordance with a zoom position or zoom amount of the zoom optical system, a second conversion coefficient storing means for storing in advance conversion coefficients corresponding to dispersion caused by at least the optical wavefront modulation optical element, and a correction value selecting means for selecting a correction value in accordance with a distance up to the object from the correction value storing means based on the information generated by the object distance information generating means, and the converting means converts the image signal according to a conversion coefficient obtained from the second conversion coefficient storing means and the correction value selected from the correction value selecting means.

Preferably, the correction value stored in the correction value storing means includes the kernel size.

An imaging apparatus according to a second aspect of the present invention includes an imaging element for capturing a dispersed image of an object passing through at least a zoom optical system, a non-zoom optical system, and an optical wavefront modulation element, a converting means for generating a dispersion-free image signal from a dispersed image signal from the imaging element, and a zoom information generating means for generating information corresponding to a zoom position or zoom amount of the zoom optical system, wherein the converting means generates a dispersion-free image signal from the dispersed image signal based on the information generated by the zoom information generating means.

Preferably, the apparatus further includes a conversion coefficient storing means for storing in advance at least two conversion coefficients corresponding to the dispersion caused by at least the optical wavefront modulation element in accordance with the zoom position or zoom amount of the zoom optical system and a coefficient selecting means for selecting a conversion coefficient in accordance with the zoom position or zoom amount of the zoom optical system from the conversion coefficient storing means based on the information generated by the zoom information generating means, wherein the converting means converts the image signal according to the conversion coefficient selected at the coefficient selecting means.

Preferably, the apparatus further includes a conversion coefficient operation means for processing a conversion coefficient based on the information generated by the zoom information generating means, and the converting means converts the image signal according to the conversion coefficient obtained from the conversion coefficient operation means.

Preferably, the apparatus further includes a correction value storing means for storing in advance at least one correction value in accordance with a zoom position or zoom amount of the zoom optical system, a second conversion coefficient storing means for storing in advance conversion coefficients corresponding to the dispersion caused by at least the optical wavefront modulation element, and a correction value selecting means for selecting a correction value in accordance with the zoom position or zoom amount of the zoom optical system from the correction value storing means based on the information generated by the zoom information generating means, and the converting means converts the image signal according to the conversion coefficient obtained from the second conversion coefficient storing means and the correction value selected by the correction value selecting means.

Preferably, the correction value stored in the correction value storing means includes the kernel size.

An imaging apparatus according to a third aspect of the present invention includes an imaging element for capturing a dispersed image of an object passing through at least an optical system and an optical wavefront modulation element, a converting means for converting a dispersed image signal from the imaging element to a dispersion-free image signal, and an imaging mode setting means for setting an imaging mode of the object to be captured, wherein the converting means performs a different conversion processing in accordance with the imaging mode set by the imaging mode setting means.

Preferably, the imaging mode includes a normal imaging mode and also at least one of a macro imaging mode or a distant view imaging mode, when it includes the macro imaging mode, the converting means selectively executes normal conversion processing in the normal imaging mode and macro conversion processing for reducing dispersion at a proximate side in comparison with the normal conversion processing in accordance with the imaging mode, and when it includes the distant view imaging mode, the converting means selectively executes normal conversion processing in the normal imaging mode and distant view conversion processing for reducing dispersion at a distant side in comparison with the normal conversion processing in accordance with the imaging mode.

Preferably, the apparatus further includes a conversion coefficient storing means for storing a different conversion coefficient in accordance with each imaging mode set by the imaging mode setting means and a conversion coefficient extracting means for extracting a conversion coefficient from the conversion coefficient storing means in accordance with the imaging mode set by the imaging mode setting means, wherein the converting means converts the image signal according to the conversion coefficient obtained from the conversion coefficient extracting means.

Preferably, the conversion coefficient storing means includes a kernel size as a conversion coefficient.

Preferably, the imaging mode setting means includes an operation switch for inputting the imaging mode and an object distance information generating means for generating information corresponding to a distance up to the object according to the input information of the operation switch, and the converting means converts the dispersed image signal to a dispersion-free image signal based on the information generated by the object distance information generating means.

An imaging method according to a fourth aspect of the present invention includes a step of capturing a dispersed image of an object passing through at least an optical system and an optical wavefront modulation element by an imaging element, an object distance information generation step of generating information corresponding to a distance up to the object, and a step of converting the dispersed image signal based on the information generated in the object distance information generation step and generating a dispersion-free image signal.

An imaging method according to a fifth aspect of the present invention includes a step of capturing a dispersed image of an object passing through at least a zoom optical system, a non-zoom optical system, and an optical wavefront modulation element by an imaging element, a zoom information generation step of generating information corresponding to the zoom position or zoom amount of the zoom optical system, and a step of converting the dispersed image signal based on the information generated in the zoom information generation step and generating a dispersion-free image signal.

A sixth aspect of the present invention includes an imaging mode setting step of setting an imaging mode of an object to be captured, an imaging step of capturing a dispersed image of an object passing through at least an optical system and an optical wavefront modulation element by an imaging element, and a conversion step of generating a dispersion-free image signal from a dispersed image signal from the imaging element by using a conversion coefficient in accordance with the imaging mode set in the imaging mode setting step.

### EFFECT OF THE INVENTION

According to the present invention, there are the advantages that the lenses can be designed without regard as to the object distance and the defocus range, and the image can be restored by convolution or other processing having a good precision, and a natural image can be obtained.

Further, according to the present invention, the optical system can be simplified, and the cost can be reduced.

Further, according to the present invention, there are the advantages that the lenses can be designed without regard as to the zoom position or zoom amount, and the image can be restored by convolution or other processing having a good precision.

Further, according to the present invention, it is possible to obtain a high definition image quality, the optical system can be simplified, and the cost can be reduced.

### BRIEF DESCRIPTION OF THE DRAWINGS

FIG. 1 is a diagram schematically showing the configuration of a general imaging lens device and a state of light beams.

FIG. 2A to FIG. 2C are diagrams showing spot images on a light receiving surface of an imaging element of the imaging lens device of FIG. 1, in which FIG. 2A is a diagram showing a spot image in a case where a focal point is deviated by 0.2 mm (defocus=0.2 mm), FIG. 2B is a diagram showing a spot image in a case of focus (best focus), and FIG. 2C is a diagram showing a spot image in a case where the focal point is deviated by 0.2 mm (defocus=−0.2 mm).

FIG. 3 is a block diagram showing the configuration of an imaging apparatus according to a first embodiment of the present invention.

FIG. 4 is a diagram schematically showing an example of the configuration of a zoom optical system of an imaging lens device according to the present embodiment.

FIG. 5 is a diagram showing the spot image on an infinite side of a zoom optical system not including a phase plate.

FIG. 6 is a diagram showing the spot image on a proximate side of a zoom optical system not including a phase plate.

FIG. 7 is a diagram showing the spot image on an infinite side of a zoom optical system including a phase plate.

FIG. 8 is a diagram showing the spot image on a proximate side of a zoom optical system including a phase plate.

FIG. 9 is a block diagram showing a concrete example of the configuration of an image processing device of the first embodiment.

FIG. 10 is a diagram for explaining a principle of the WFCO in the first embodiment.

FIG. 11 is a flow chart for explaining an operation of the first embodiment.

FIG. 12A to FIG. 12C are diagrams showing spot images on the light receiving surface of an imaging element of an imaging lens device according to the present embodiment, in which FIG. 12A is a diagram showing a spot image in the case where the focal point is deviated by 0.2 mm (defocus=0.2 mm), FIG. 2B is a diagram showing a spot image in the case of focus (best focus), and FIG. 2C is a diagram showing a spot image in the case where the focal point is deviated by 0.2 mm (defocus=−0.2 mm).

FIGS. 13A and 13B are diagrams for explaining MTF of a first order image formed by an imaging lens device according to the present embodiment, in which FIG. 13A is a diagram showing a spot image on the light receiving surface of an imaging element of an imaging lens device, and FIG. 13B shows an MTF characteristic with respect to a spatial frequency.

FIG. 14 is a diagram for explaining MTF correction processing in an image processing device according to the present embodiment.

FIG. 15 is a diagram for concretely explaining MTF correction processing in an image processing device according to the present embodiment.

FIG. 16 is a block diagram showing the configuration of an imaging apparatus according to a second embodiment of the resent invention.

FIG. 17 is a block diagram showing a concrete example of the configuration of an image processing device of the second embodiment.

FIG. 18 is a diagram for explaining the principle of the WFCO in the second embodiment.

FIG. 19 is a flow chart for explaining the operation in the second embodiment.

FIG. 20 is a block diagram showing the configuration of an imaging apparatus according to a third embodiment of the present invention.

FIG. 21 is a block diagram showing a concrete example of the configuration of an image processing device of the third embodiment.

FIG. 22 is a diagram for explaining the principle of the WFCO in the third embodiment.

FIG. 23 is a flow chart for explaining the operation in the third embodiment.

FIG. 24 is a block diagram showing the configuration of an imaging apparatus according to a fourth embodiment of the present invention.

FIG. 25 is a diagram showing an example of the configuration of operation switches according to the fourth embodiment.

FIG. 26 is a block diagram showing a concrete example of the configuration of an image processing device of the fourth embodiment.

FIG. 27 is a diagram for explaining the principle of the WFCO in the fourth embodiment.

FIG. 28 is a flow chart for explaining the operation in the fourth embodiment.

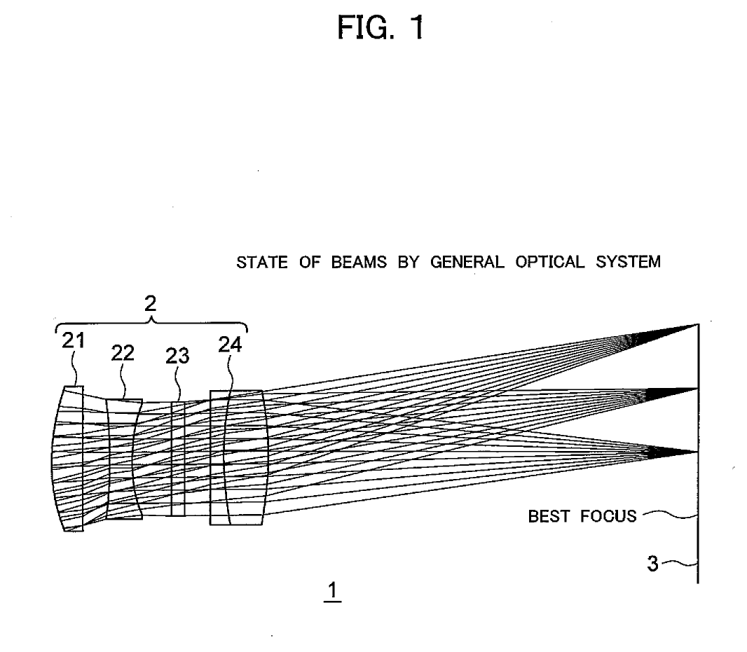

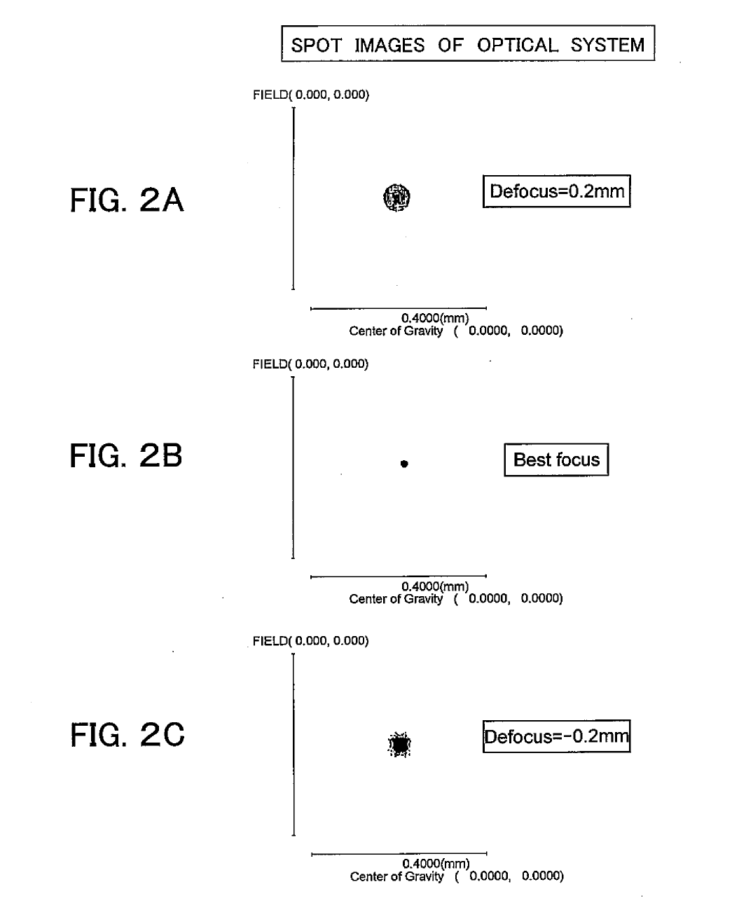

### DESCRIPTION OF NOTATIONS

100, 100A to 100C . . . imaging apparatuses, 200 . . . imaging lens device, 211 . . . object side lens, 212 . . . imaging lens, 213 . . . wavefront forming optical elements, 213a . . . phase plate (optical wavefront modulation element), 300, 300A to 300C . . . image processing devices, 301, 301A to 301C . . . convolution devices, 302, 302A to 302C . . . kernel and/or numerical value operational coefficient storage registers, 303, 303A to 303C . . . image processing computation processors, 400, 400C . . . object schematic distance information detection devices, 401 . . . operation switches, 402 . . . imaging mode setting unit, and 500 . . . zoom information detection device.

### BEST MODE FOR WORKING THE INVENTION

Below, embodiments of the present invention will be explained with reference to the accompanying drawings.

### First Embodiment

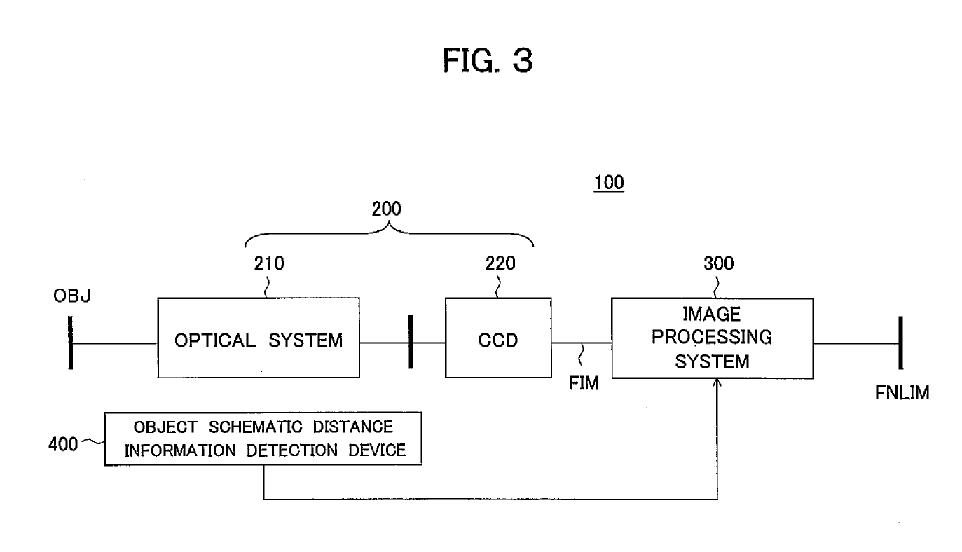

FIG. 3 is a block diagram showing the configuration of an imaging apparatus according to a first embodiment of the present invention.

An imaging device 100 according to the present embodiment has an imaging lens device 200 having a zoom optical system, an image processing device 300, and an object schematic distance information detection device 400 as principal components.

The imaging lens device 200 has a zoom optical system 210 for optically capturing an image of an imaging object (object) OBJ, and an imaging element 220 formed by an CCD or CMOS sensor in which the image captured at the zoom optical system 210 is focused and which outputs a focused first order image information as a first order image signal FIM of an electric signal to the image processing device 300. In FIG. 3, the imaging element 220 is described as a CCD as an example.

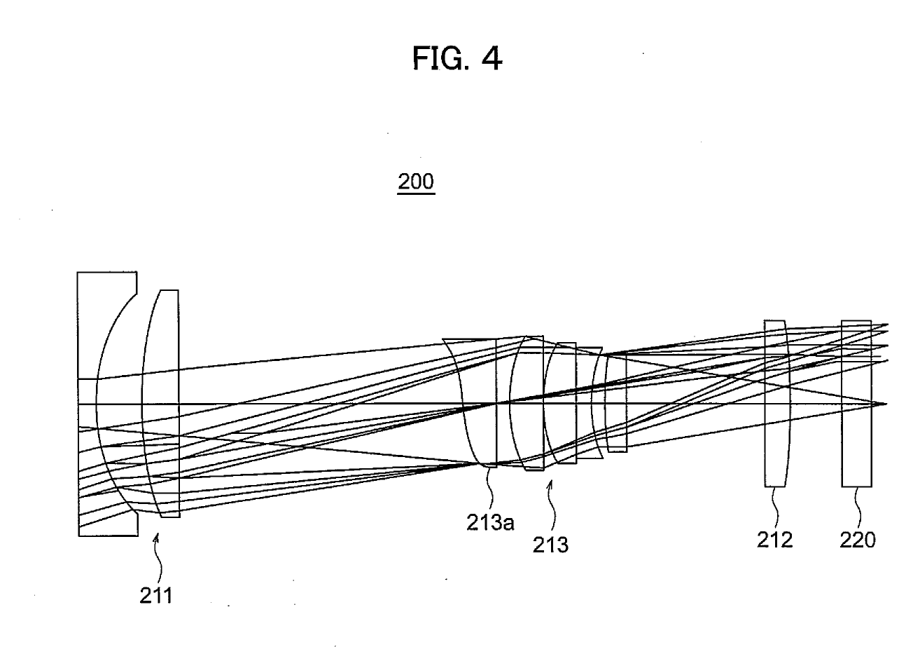

FIG. 4 is a diagram schematically showing an example of the configuration of the optical system of the zoom optical system 210 according to the present embodiment.

The zoom optical system 210 of FIG. 4 has an object side lens 211 arranged on the object side OBJS, an imaging lens 212 for forming an image in the imaging element 220, and an optical wavefront modulation element (wavefront forming optical element: wavefront coding optical element) group 213 arranged between the object side lens 211 and the imaging lens 212 and including a phase plate (cubic phase plate) deforming the wavefront of the image formed on the light receiving surface of the imaging element 220 by the imaging lens 212 and having for example a three-dimensional curved surface. Further, a not shown stop is arranged between the object side lens 211 and the imaging lens 212.

Note that, in the present embodiment, an explanation was given of the case where a phase plate was used, but the optical wavefront modulation elements of the present invention may include any elements so far as they deforms the wavefront. They may include optical elements changing in thickness (for example, the above-explained third order phase plate), optical elements changing in refractive index (for example, a refractive index distribution type wavefront modulation lens), optical elements changing in thickness and refractive index by the coding on the lens surface (for example, a wavefront coding hybrid lens), liquid crystal devices able to modulate the phase distribution of the light (for example, liquid crystal spatial phase modulation devices), and other optical wavefront modulation elements.

The zoom optical system 210 of FIG. 4 is an example of inserting an optical phase plate 213a into a 3× zoom system used in a digital camera.

The phase plate 213a shown in the figure is an optical lens regularly dispersing the light beams converged by the optical system. By inserting this phase plate, an image not focused anywhere on the imaging element 220 is realized.

In other words, the phase plate 213a forms light beams having a deep depth (playing a central role in the image formation) and a flare (blurred portion).

A means for restoring this regularly dispersed image to a focused image by digital processing will be referred to as a “wavefront aberration control optical system (wavefront coding optical system (WFCO))”. This processing is carried out in the image processing device 300.

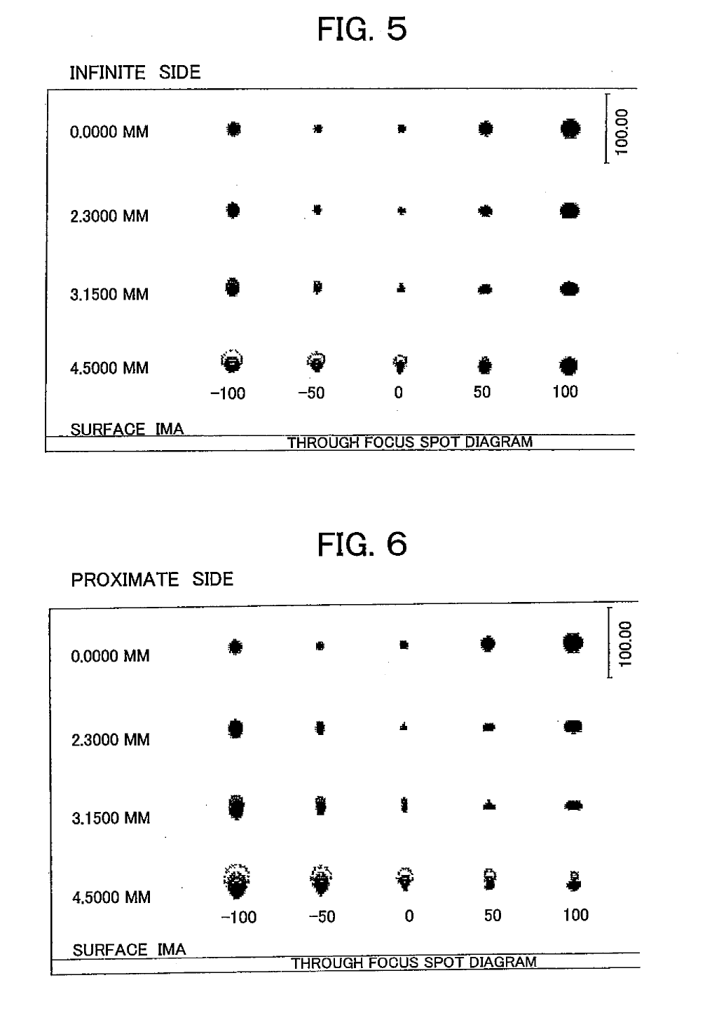

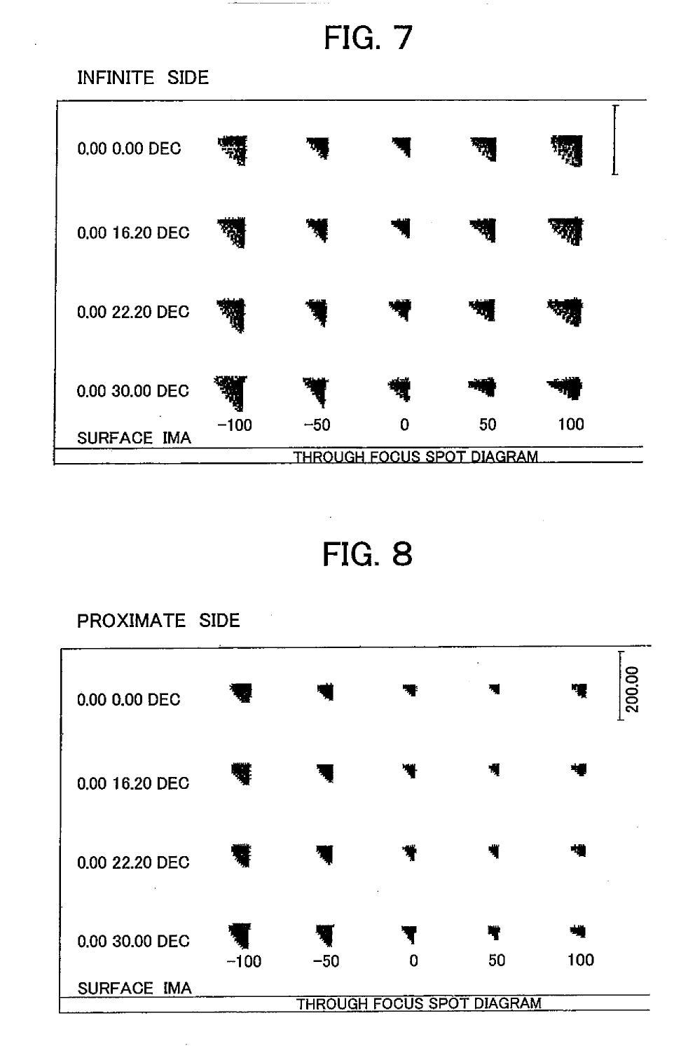

FIG. 5 is a diagram showing a spot image on the infinite side of a zoom optical system 210 not including a phase plate. FIG. 6 is a diagram showing a spot image on the proximate side of a zoom optical system 210 not including a phase plate. FIG. 7 is a diagram showing a spot image on the infinite side of a zoom optical system 210 including a phase plate. FIG. 8 is a diagram showing the spot image on the proximate side of a zoom optical system 210 including a phase plate.

Basically, the spot image of light passing through an optical lens system not including a phase plate, as shown in FIG. 5 and FIG. 6, differs between the case where the object distance thereof is at the proximate side and the case where it is at the infinite side.

In this way, in an optical system having a spot image differing according to the object distance, an H function explained later is different.

Naturally, as shown in FIG. 7 and FIG. 8, a spot image passed through the phase plate influenced by this spot image also differs between the case where the object position is at the proximate side and the case where it is at the infinite side.

In an optical system having such a spot image differing according to the object position, suitable convolution processing cannot be performed in a general imaging apparatus. Therefore, an optical design eliminating astigmatism, coma aberration, spherical aberration, and other aberration is required. However, an optical design for eliminating these aberrations increases the difficulty of the optical design and causes the problems of an increase of the number of design processes, a cost increase, and an increase of the size of the lenses.

Therefore, in the first embodiment, as shown in FIG. 3, at the point of time when the imaging apparatus (camera) 100 enters into the imaging state, the schematic distance of the object distance of the object is read out from the object schematic distance information detection device 400 and supplied to the image processing device 300.

The image processing device 300 generates a dispersion-free image signal from the dispersed image signal from the imaging element 220 based on the schematic distance information of the object distance of the object read out from the object schematic distance information detection device 400.

The object schematic distance information detection device 400 may be an AF sensor such as external active sensor.

Note that, in the present embodiment, “dispersion” means the phenomenon where as explained above, inserting the phase plate 213a causes the formation of an image note focused anywhere on the imaging element 220 and the formation of light beams having a deep depth (playing a central role in the image formation) and flare (blurred portion) by the phase plate 213a and includes the same meaning as aberration because of the behavior of the image being dispersed and forming a blurred portion. Accordingly, in the present embodiment, there also exists a case where dispersion is explained as aberration.

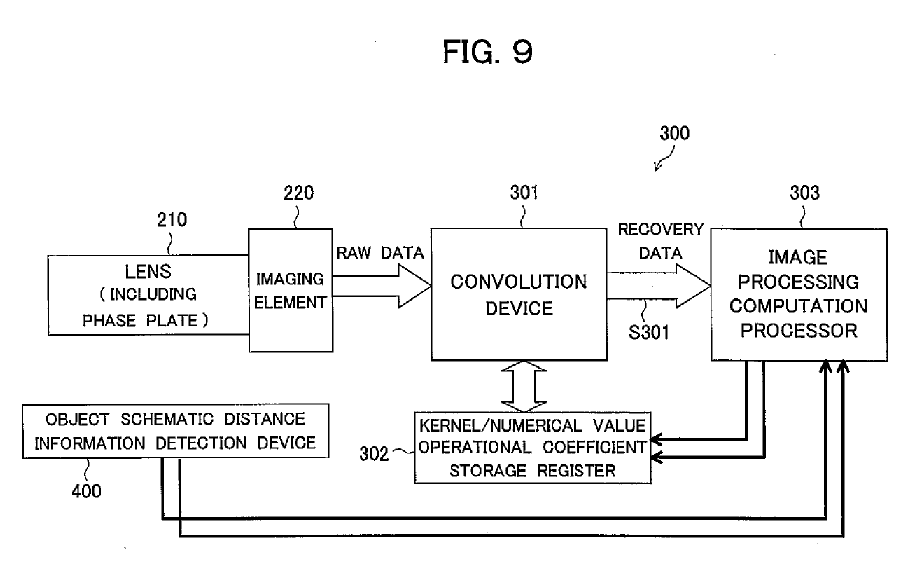

FIG. 9 is a block diagram showing an example of the configuration of the image processing device 300 for generating a dispersion-free signal from a dispersed image signal from the imaging element 220.

The image processing device 300, as shown in FIG. 9, has a convolution device 301, a kernel and/or numerical value operational coefficient storage register 302, and an image processing computation processor 303.

In this image processing device 300, the image processing computation processor 303 obtaining information concerning the schematic distance of the object distance of the object read out from the object schematic distance information detection device 400 stores the kernel size and its operational coefficients used in suitable operation with respect to the object distance position in the kernel and/or numerical value operational coefficient storage register 302 and performs the suitable operation at the convolution device 301 by using those values for operation to restore the image.

Here, the basic principle of the WFCO will be explained.

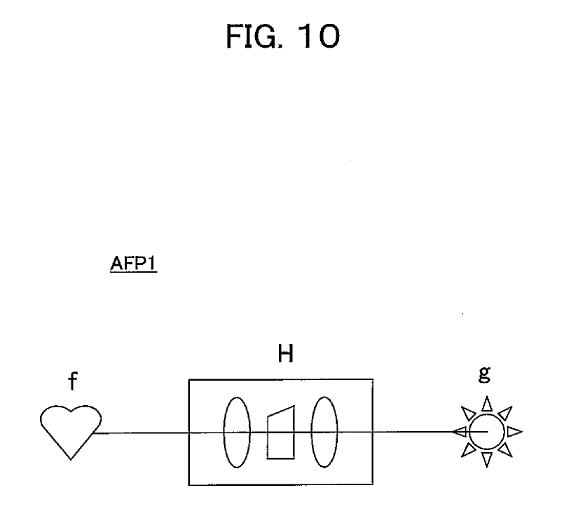

As shown in FIG. 10, an image f of the object enters into the WFCO optical system H, whereby a g image is generated.

This can be represented by the following equation.
g=H*f (Equation 1)

Here, * indicates convolution.

In order to find the object from the generated image, the next processing is required.
f=H⁻¹*g (Equation 2)

Here, the kernel size and operational coefficients concerning the function H will be explained.

Assume that the individual object schematic distances are AFPn, AFPn−1, . . . , and assume the individual zoom positions are Zpn, Zpn−1, . . . .

Assume that the H functions thereof are Hn, Hn−1, . . . .

The spots are different, therefore the H functions become as follows.

$$Hn = ( \begin{matrix}a & b & c \\ d & e & f\end{matrix} ) \\ Hn - 1 = ( \begin{matrix}a′ & b′ & c′ \\ d′ & e′ & f′ \\ g′ & h′ & i′\end{matrix} ) \qquad [ Equation 3 ]$$

The difference of the number of rows and/or the number of columns of this matrix is referred to as the “kernel size”. The numbers are the operational coefficients.

As explained above, in the case of an imaging apparatus provided with a phase plate as an optical wavefront modulation element (wavefront coding optical element), if within a predetermined focal distance range, a suitable aberration-free image signal can be generated by image processing concerning that range, but if out of the predetermined focal length range, there is a limit to the correction of the image processing, therefore only an object out of the above range ends up becoming an image signal with aberration.

Further, on the other hand, by applying image processing not causing aberration within a predetermined narrow range, it also becomes possible to give blurriness to an image out of the predetermined narrow range.

The present embodiment is configured so as to detect the distance up to the main object by the object schematic distance information detection device 400 including the distance detection sensor and perform processing for image correction different in accordance with the detected distance.

The above image processing is carried out by convolution operation. In order to accomplish this, for example, it is possible to commonly storing one type of operational coefficient of the convolution operation, store in advance a correction coefficient in accordance with the focal length, correct the operational coefficient by using this correction coefficient, and perform suitable convolution processing by the corrected operational coefficient.

Other than this configuration, it is possible to employ the following configurations.

It is possible to employ a configuration storing in advance the kernel size and the operational coefficient itself of the convolution in accordance with the focal length and perform convolution operation by these stored kernel size and operational coefficient, a configuration storing in advance the operational coefficient in accordance with a focal length as a function, finding the operational coefficient by this function according to the focal length, and performing the convolution operation by the calculated operational coefficient, and so on.

When linked with the configuration of FIG. 9, the following configuration can be employed.

At least two conversion coefficients corresponding to the aberration due to at least the phase plate 213a are stored in advance in the register 302 as the conversion coefficient storing means in accordance with the object distance. The image processing computation processor 303 functions as the coefficient selecting means for selecting a conversion coefficient in accordance with the distance up to the object from the register 302 based on the information generated by the object schematic distance information detection device 400 as the object distance information generating means.

Then, the convolution device 301 as the converting means converts the image signal according to the conversion coefficient selected at the image processing computation processor 303 as the coefficient selecting means.

Alternatively, as explained above, the image processing computation processor 303 as the conversion coefficient operation means computes the conversion coefficient based on the information generated by the object schematic distance information detection device 400 as the object distance information generating means by and stores the same in the register 302.

Then, the convolution device 301 as the converting means converts the image signal according to the conversion coefficient obtained by the image processing computation processor 303 as the conversion coefficient operation and stored in the register 302.

Alternatively, at least one correction value in accordance with the zoom position or zoom amount of the zoom optical system 210 is stored in advance the register 302 as the correction value storing means. This correction value includes the kernel size of the object aberration image.

The register 302, functioning also as the second conversion coefficient storing means, stores in advance the conversion coefficient corresponding to the aberration due to the phase plate 213a.

Then, based on the distance information generated by the object schematic distance information detection device 400 as the object distance information generating means, the image processing computation processor 303 as the correction value selecting means selects the correction value in accordance with the distance up to the object from the register 302 as the correction value storing means.

The convolution device 301 as the converting means converts the image signal based on the conversion coefficient obtained from the register 302 as the second conversion coefficient storing means and the correction value selected by the image processing computation processor 303 as the correction value selecting means.

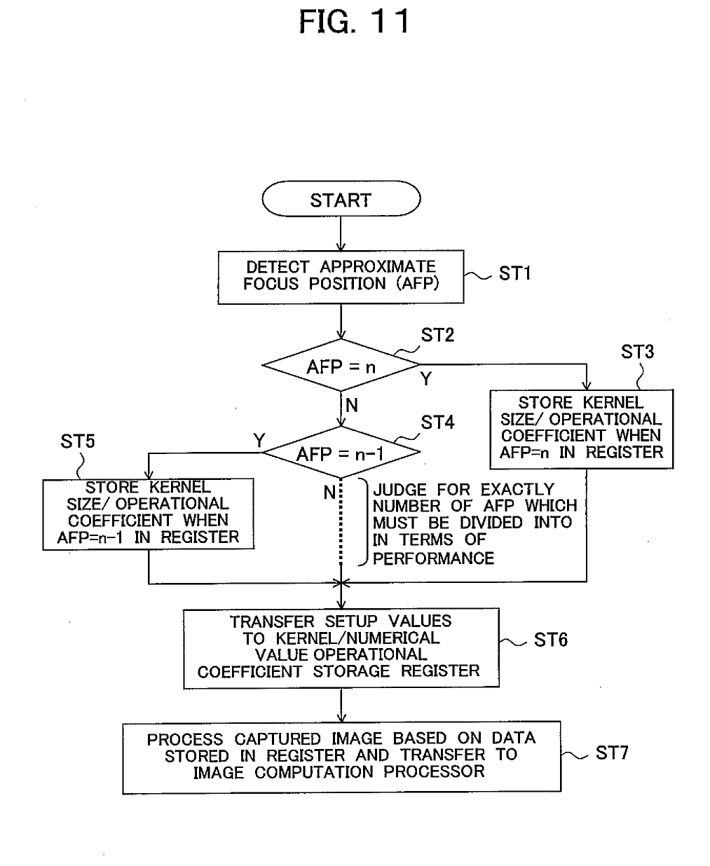

Next, the concrete processing of the case where the image processing computation processor 303 functions as the conversion coefficient operation means will be explained with reference to the flow chart of FIG. 11.

The object schematic distance information detection device 400 detects the approximate focus position (AFP) and supplies the detection information to the image processing computation processor 303 (ST1).

The image processing computation processor 303 judges whether or not the approximate focus position AFP is n (ST2).

When it is judged at step ST1 that the approximate focus position AFP is n, the kernel size and operational coefficient where AFP=n are found and stored in the register (ST3).

When it is judged at step ST1 that the approximate focus position AFP is not n, it is judged whether or not the approximate focus position AFP is n−1 (ST4). When it is judged at step ST4 that the approximate focus position AFP is n−1, the kernel size and operational coefficient where AFP=n−1 are found and stored in the register (ST5).

After this, the judgment processing of steps ST2 and ST4 is carried out for exactly the number of the approximate focus positions AFPs which must be divided into in terms of performance, and the kernel sizes and the operational coefficients are stored in the register.

The image processing computation processor 303 transfers the set values to the kernel and/or numerical value processing coefficient storage register 302 (ST6).

Then, the image data captured at the imaging lens device 200 and input to the convolution device 301 is processed by convolution operation based on the data stored in the register 302, and the processed and converted data S302 is transferred to the image processing computation processor 303.

In the present embodiment, the WFCO is employed so it is possible to obtain a high definition image quality. In addition, the optical system can be simplified, and the cost can be reduced.

Below, these characteristic features will be explained.

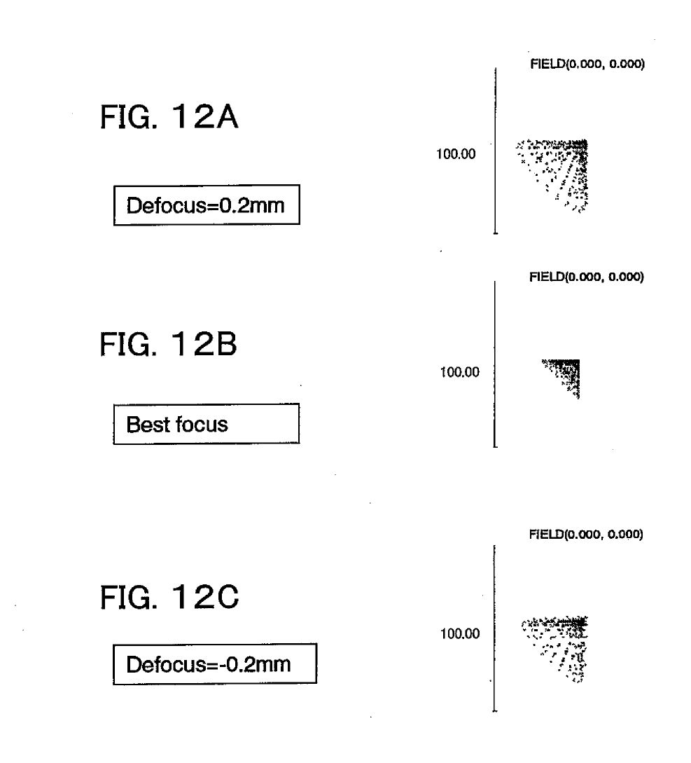

FIG. 12A to FIG. 12C show spot images on the light reception surface of the imaging element 220 of the imaging lens device 200.

FIG. 12A is a diagram showing a spot image in the case where the focal point is deviated by 0.2 mm (defocus=0.2 mm), FIG. 12B is a diagram showing a spot image in the case of focus (best focus), and FIG. 12C is a diagram showing a spot image in the case where the focal point is deviated by 0.2 mm (defocus=−0.2 mm).

As seen also from FIG. 12A to FIG. 12C, in the imaging lens device 200 according to the present embodiment, light beams having a deep depth (playing a central role in the image formation) and a flare (blurred portion) are formed by the wavefront forming optical element group 213 including the phase plate 213a.

In this way, the first order image FIM formed in the imaging lens device 200 of the present embodiment is given light beam conditions resulting in deep depth.

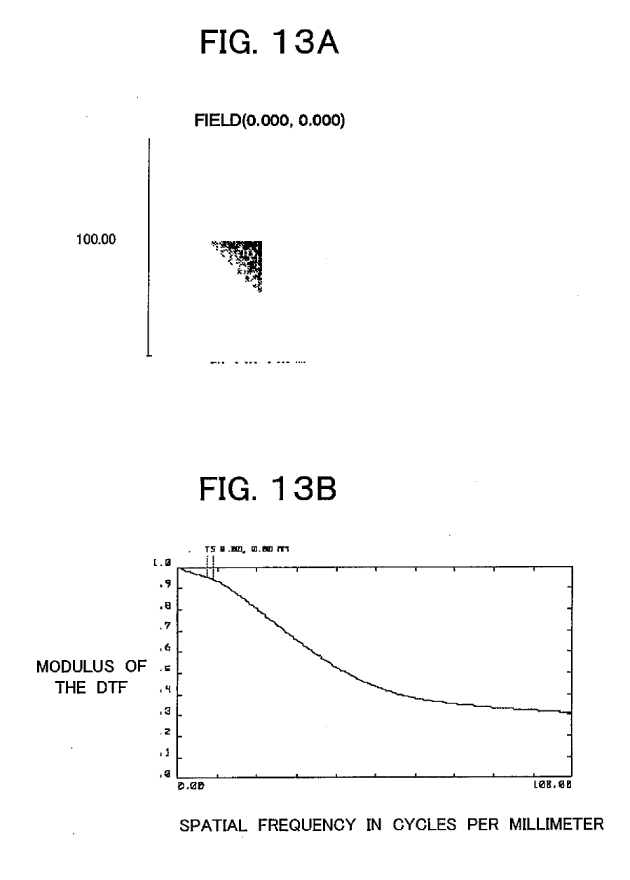

FIGS. 13A and 13B are diagrams for explaining a modulation transfer function (MTF) of the first order image formed by the imaging lens device according to the present embodiment, in which FIG. 13A is a diagram showing a spot image on the light receiving surface of the imaging element of the imaging lens device, and FIG. 13B shows the MTF characteristic with respect to the spatial frequency.

In the present embodiment, the high definition final image is left to the correction processing of the latter stage image processing device 300 configured by, for example, a digital signal processor. Therefore, as shown in FIGS. 13A and 13B, the MTF of the first order image essentially becomes a very low value.

The image processing device 300 is configured by for example a DSP and, as explained above, receives the first order image FIM from the imaging lens device 200, applies predetermined correction processing etc. for boosting the MTF at the spatial frequency of the first order image, and forms a high definition final image FNLIM.

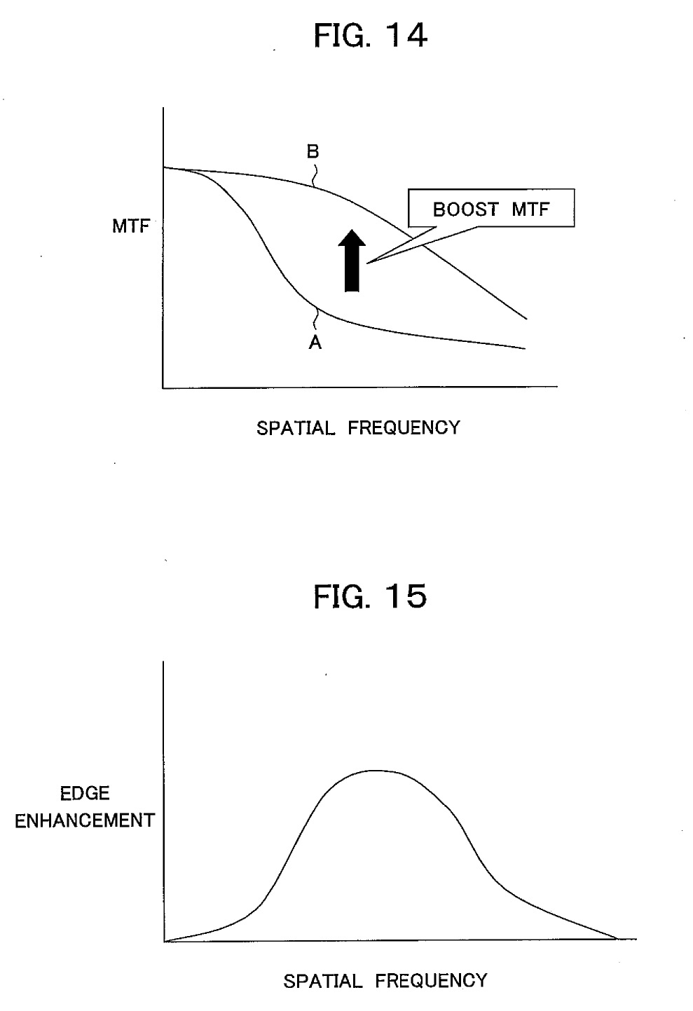

The MTF correction processing of the image processing device 300 performs correction so that, for example as indicated by a curve A of FIG. 14, the MTF of the first order image which essentially becomes a low value approaches (reaches) the characteristic indicated by a curve B in FIG. 14 by post-processing such as edge enhancement and chroma enhancement by using the spatial frequency as a parameter.

The characteristic indicated by the curve B in FIG. 14 is the characteristic obtained in the case where the wavefront forming optical element is not used and the wavefront is not deformed as in for example the present embodiment.

Note that all corrections in the present embodiment are according to the parameter of the spatial frequency.

In the present embodiment, as shown in FIG. 14, in order to achieve the MTF characteristic curve B desired to be finally realized with respect to the MTF characteristic curve A for the optically obtained spatial frequency, the strength of the edge enhancement etc. is adjusted for each spatial frequency, to correct the original image (first order image).

For example, in the case of the MTF characteristic of FIG. 14, the curve of the edge enhancement with respect to the spatial frequency becomes as shown in FIG. 15.

Namely, by performing the correction by weakening the edge enhancement on the low frequency side and high frequency side within a predetermined bandwidth of the spatial frequency and strengthening the edge enhancement in an intermediate frequency zone, the desired MTF characteristic curve B is virtually realized.

In this way, the imaging apparatus 100 according to the embodiment is an image forming system configured by the imaging lens device 200 including the optical system 210 for forming the first order image and the image processing device 300 for forming the first order image to a high definition final image, wherein the optical system is newly provided with a wavefront forming optical element or is provided with a glass, plastic, or other optical element with a surface shaped for wavefront forming use so as to deform the wavefront of the image formed, such a wavefront is focused onto the imaging surface (light receiving surface) of the imaging element 220 formed by a CCD or CMOS sensor, and the focused first order image is passed through the image processing device 300 to obtain the high definition image.

In the present embodiment, the first order image from the imaging lens device 200 is given light beam conditions with very deep depth. For this reason, the MTF of the first order image inherently becomes a low value, and the MTF thereof is corrected by the image processing device 300.

Here, the process of image formation in the imaging lens device 200 of the present embodiment will be considered in terms of wave optics.

A spherical wave scattered from one point of an object point becomes a converged wave after passing through the imaging optical system. At that time, when the imaging optical system is not an ideal optical system, aberration occurs. The wavefront becomes not spherical, but a complex shape. Geometric optics and wave optics is bridged by wavefront optics. This is convenient in the case where a wavefront phenomenon is handled.

When handling a wave optical MTF on an imaging plane, the wavefront information at an exit pupil position of the imaging optical system becomes important.

The MTF is calculated by a Fourier transform of the wave optical intensity distribution at the imaging point. The wave optical intensity distribution is obtained by squaring the wave optical amplitude distribution. That wave optical amplitude distribution is found from a Fourier transform of a pupil function at the exit pupil.

Further, the pupil function is the wavefront information (wavefront aberration) at the exit pupil position, therefore if the wavefront aberration can be strictly calculated as a numerical value through the optical system 210, the MTF can be calculated.

Accordingly, if modifying the wavefront information at the exit pupil position by a predetermined technique, the MTF value on the imaging plane can be freely changed.

In the present embodiment as well, the shape of the wavefront is mainly changed by a wavefront forming optical element. It is truly the phase (length of light path along the rays) that is adjusted to form the desired wavefront.

Then, when forming the target wavefront, the light beams from the exit pupil are formed by a dense ray portion and a sparse ray portion as seen from the geometric optical spot images shown in FIG. 12A to FIG. 12C.

The MTF of this state of light beams exhibits a low value at a position where the spatial frequency is low and somehow maintains the resolution up to the position where the spatial frequency is high.

Namely, if this low MTF value (or, geometric optically, the state of the spot image), the phenomenon of aliasing will not be caused.

That is, a low pass filter is not necessary.

Further, the flare-like image causing a drop in the MTF value may be eliminated by the image processing device 300 configured by the later stage DSP etc. Due to this, the MTF value is remarkably improved.

As explained above, according to the first embodiment, since the apparatus has the imaging lens device 200 for capturing a dispersed image of an object passing through the optical system and the phase plate (optical wavefront modulation element), the image processing device 300 for generating a dispersion-free image signal from dispersed image signal from the imaging element 220, and the object schematic distance information detection device 400 for generating information corresponding to the distance up to the object, and the image processing device 300 generates a dispersion-free image signal from the dispersed image signal based on the information generated by the object schematic distance information detection device 400, there are the advantages that by making the kernel size used at the time of the convolution operation and the coefficients used in the operation of the numerical values variable, measuring the schematic distance of the object distance, and linking the kernel size having suitability in accordance with the object distance or the above coefficients, the lenses can be designed without regard as to the object distance and defocus range and the image can be restored by high precision convolution.

Further, the imaging apparatus 100 according to the present embodiment can be used for the WFCO of a zoom lens designed considering small size, light weight, and cost in a digital camera, camcorder, or other consumer electronic device.

Further, in the present embodiment, since the apparatus has the imaging lens device 200 having the wavefront forming optical element for deforming the wavefront of the image formed on the light receiving surface of the imaging element 220 by the imaging lens 212 and the image processing device 300 for receiving the first order image FIM from the imaging lens device 200 and applying predetermined correction processing etc. to boost the MTF at the spatial frequency of the first order image and form the high definition final image FNLIM, there is the advantage that the acquisition of a high definition image quality becomes possible.

Further, the configuration of the optical system 210 of the imaging lens device 200 can be simplified, production becomes easy, and the cost can be reduced.

### Second Embodiment

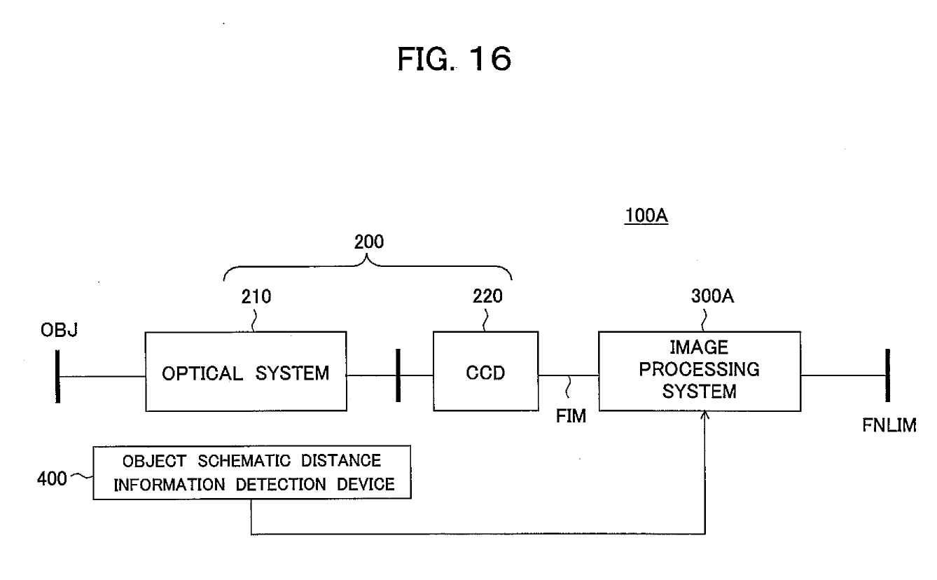

FIG. 16 is a block diagram showing the configuration of an imaging apparatus according to a second embodiment of the present invention.

An imaging apparatus 100A according to the second embodiment has an imaging lens device 200 having a zoom optical system 210, an image processing device 300A, and an object schematic distance information detection device 400 as principal components.

Namely, the imaging apparatus 100A according to the second embodiment basically has the same configuration as that of the imaging apparatus 100 according to the first embodiment shown in FIG. 3.

The zoom optical system 210 also has the same configuration as the configuration shown in FIG. 4. Further, in the image processing device 300A, the means for restoring the regularly dispersed image to a focused image by digital processing functions as a “wavefront aberration control optical system (wavefront coding optical system (WFCO))”.

As explained before, in an optical system having a spot image differing according to the object position, in a general imaging apparatus, suitable convolution operation is not possible. An optical design eliminating the astigmatism, coma aberration, zoom chromatic aberration, and other aberration causing deviation of the spot image is required. However, optical design eliminating these aberrations increases the difficulty of the optical design and induces problems such as an increase of the number of design processes, an increase of the costs, and an increase in size of the lenses. Further, when designing the optical system to correct astigmatism, coma aberration, spherical aberration, and other aberration inducing deviation of the spot T image, if restoring the image, the image ends up becoming one focused over the entire screen. The picture-making required for application to a digital camera or camcorder etc., that is, a so-called “natural image” where the object desired to be captured is in focus, but the background is blurred cannot be realized.

Therefore, in the second embodiment, as shown in FIG. 16, at the point of time when the imaging apparatus (camera) 100 enters into the imaging state, the schematic distance of the object distance of that object is read out from the object schematic distance information detection device 400 and supplied to the image processing device 300A.

The image processing device 300A, based on the schematic distance information of the object distance of the object read out from the object schematic distance information detection device 400, generates a dispersion-free image signal from the dispersed image signal from the imaging element 220.

The object schematic distance information detection device 400 may be an AF sensor like an external active sensor.

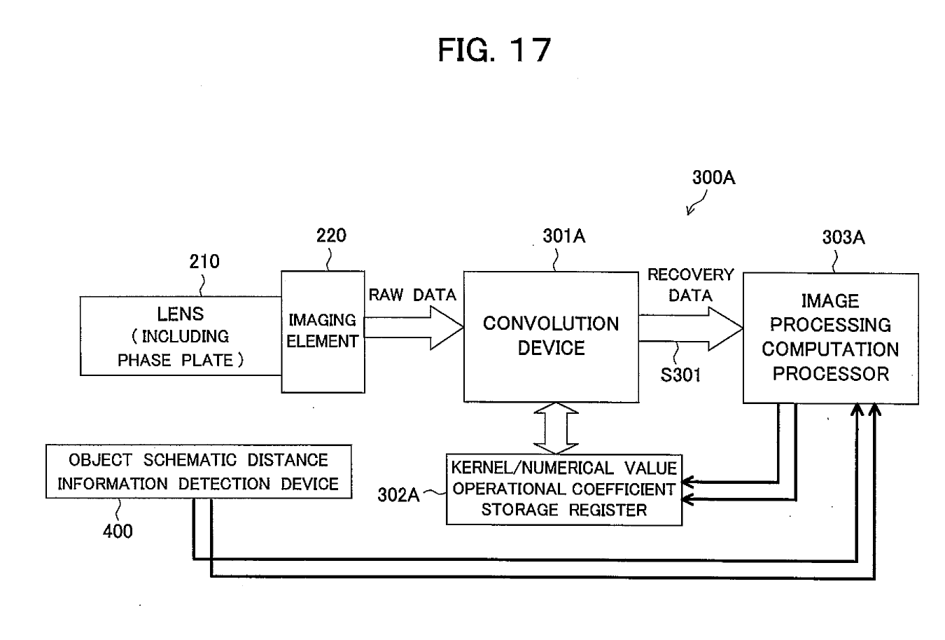

FIG. 17 is a block diagram showing an example of the configuration of the image processing device 300A generating a dispersion-free image signal from the dispersed image signal from the imaging element 220.

The image processing device 300A basically has the same configuration as that of the image processing device 300 of the first embodiment shown in FIG. 4.

Namely, the image processing device 300A, as shown in FIG. 17, has a convolution device 301A, a kernel and/or numerical value operational coefficient storage register 302A as a storing means, and an image processing computation processor 303A.

In this image processing device 300A, the image processing computation processor 303A obtaining the information concerning the schematic distance of the object distance of the object read out from the object schematic distance information detection device 400 stores the kernel size and its operational coefficient used in suitable operation with respect to the object distance position in the kernel and/or numerical value operational coefficient storage register 302A, performs suitable operation in the convolution device 301A performing operation by using those values, and thereby restores the image.

Here, the basic principle of the WFCO will be explained.

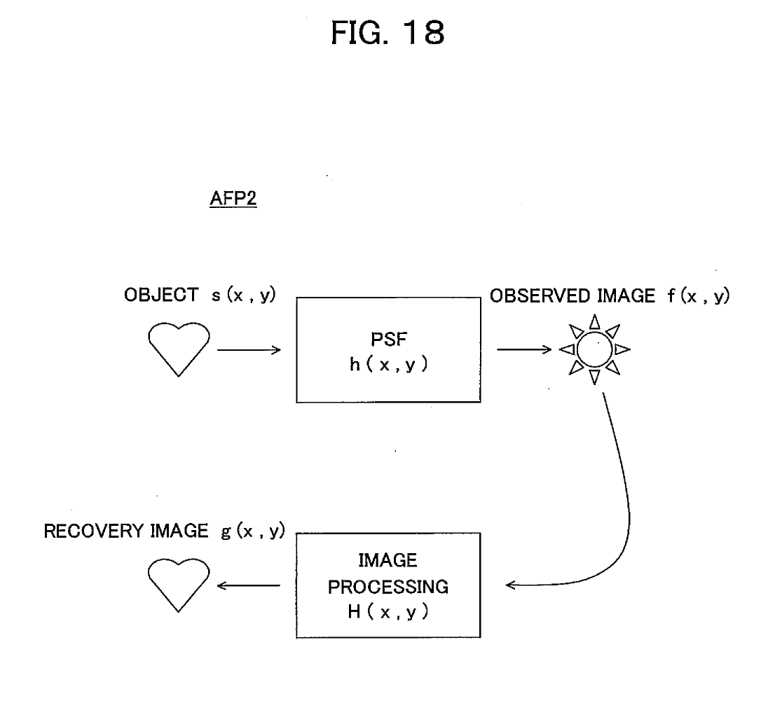

As shown in FIG. 18, when the object to be measured is s(x,y) and the weight function causing blurring in the measurement (point spread function PSF) is h(x,y), the measured observed image f(x,y) is represented by the following equation:
f(x,y)=s(x,y)*h(x,y) (Equation 4)
Note, that * represents convolution.

The signal recovery in WFCO finds s(x,y) from the observed image f(x,y). In order to recover the signal, for example, the original image s(x,y) is recovered by performing the following processing (multiplication) on f(x,y).
H(x,y)=h⁻¹(x,y) (Equation 5)

Namely, it can be represented as follows.
g(x,y)=f(x,y)*H(x,y)→s(x,y) (Equation 6)

Note that H(x,y) is not limited to the inverse filter as described above. Various types of filters for obtaining g(x,y) may be used.

Here, the kernel size and operational coefficients concerning H will be explained.

Assume the object schematic distances FPn, FPn−1, . . . . Further, assume the H functions with respect to the object schematic distances are Hn, Hn−1, . . . .

The spot images differ according to the object distances. That is, the PSFs used for generating the filter differ, therefore the H function of each differs according to the object distance.

Accordingly, the H functions become as follows.

$$Hn = ( \begin{matrix}a & b & c \\ d & e & f\end{matrix} ) \\ Hn - 1 = ( \begin{matrix}a′ & b′ & c′ \\ d′ & e′ & f′ \\ g′ & h′ & i′\end{matrix} ) \qquad [ Equation 7 ]$$

The difference of the number of rows and/or the number of columns of this matrix is referred to as the “kernel size”. The numbers are the operational coefficients.

Here, each H function may be stored in the memory. By using the PSF as a function of the object distance, using the object distance for calculation, and calculating the H function, it is also possible to set the system so as to create the optimum filter for any object distance. Further, it is also possible to use the H function as a function of the object distance and directly find the H function by the object distance.

As explained above, in the case of an imaging apparatus provided with a phase plate as an optical wavefront modulation element, if within a predetermined focal distance range, a suitable aberration-free image signal can be generated by image processing concerning that range, but if out of the predetermined focal length range, there is a limit to the correction of the image processing, therefore only an object out of the above range ends up becoming an image signal with aberration.

Further, on the other hand, by applying image processing not causing aberration within a predetermined narrow range, it also becomes possible to give blurriness to an the image out of the predetermined narrow range.

The present embodiment is configured to detect the distance up to the main object by the object schematic distance information detection device 400 including the distance detection sensor and perform processing for image correction differing in accordance with the detected distance.

The above image processing is carried out by convolution operation. In order to accomplish this, for example, an operational coefficient in accordance with the object distance is stored in advance as a function, the operational coefficient is found by this function according to the focal length, and the convolution processing is carried out by the computed operational coefficient.

Other than this configuration, it is possible to employ the following configurations.

It is possible to employ a configuration commonly storing one type of operational coefficient for convolution operation, storing in advance a correction coefficient in accordance with the object distance, correcting the operational coefficient by using this correction coefficient, and performing adaptive convolution operation by the corrected operational coefficient, a configuration storing in advance the kernel size and the operational coefficient per se of convolution in accordance with the object distance and performing the convolution operation by these stored kernel size and operational coefficient, and so on.

When linking this with the configuration of FIG. 17, the following configuration can be employed.

As explained before, the image processing computation processor 303A as the conversion coefficient operation means processes the conversion coefficient based on the information generated by the object schematic distance information detection device 400 as the object distance information generating means and stores the same in the register 302A.

Then, the convolution device 301A as the converting means converts the image signal according to the conversion coefficient obtained in the image processing computation processor 303A as the conversion coefficient operation means and stored in the register 302A.

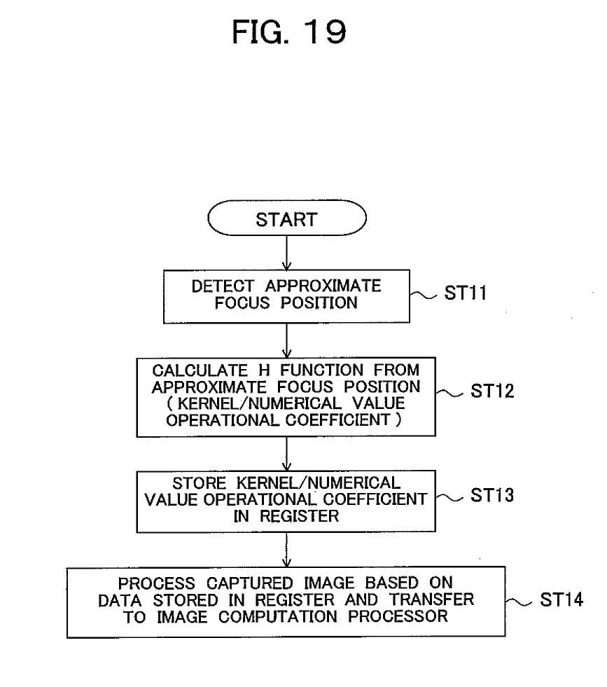

Next, the concrete processing in the case where the image processing computation processor 303A functions as the conversion coefficient operation means will be explained with reference to the flow chart of FIG. 19.

The object schematic distance information detection device 400 detects the approximate focus position (FP) and supplies the detected information to the image processing computation processor 303A (ST11).

The image processing computation processor 303A calculates the H function (kernel size, numerical value operational coefficient) from the approximate focus position FP (ST12).

The calculated kernel size and numerical value operational coefficient are stored in the register 302A (ST13).

Then, the image data captured at the imaging lens device 200 and input to the convolution device 301A is processed by convolution processing based on the data stored in the register 302A. The processed and converted data S302 is transferred to the image processing computation processor 303A (ST14).

The present embodiment employs the WFCO and can obtain a high definition image quality. In addition, it is possible to simplify the optical system and possible to reduce the costs.

These characteristic features were explained in detail in the first embodiment, so the explanation thereof is omitted here.

As explained above, according to the second embodiment, since the apparatus has the imaging lens device 200 for capturing the dispersed image of an object passing through the optical system and the phase plate (optical wavefront modulation element), the convolution device 301A for generating a dispersion-free image signal from a dispersed image signal from the imaging element 220, the object schematic distance information detection device 400 for generating information corresponding to the distance up to the object, and the image processing computation processor 303A for processing the conversion coefficient based on the information generated by the object schematic distance information detection device 400 and since the convolution device 301A converts the image signal according to the conversion coefficient obtained from the image processing computation processor 303A and generates a dispersion-free image signal, there are the advantages that by making the kernel size used at the time of the convolution operation and the coefficient used in the numerical value operation variable, measuring the schematic distance of the object distance, and linking the suitable kernel size in accordance with the object distance and the coefficient explained above, the lenses can be designed without regard as to the object distance and defocus length and the image can be restored by high precision convolution.

Further, there are the advantages that a so-called natural image where the image to be captured is in focus, but the background is blurred can be obtained without requiring optical lenses having a high difficulty, expensive cost, and large size and without driving the lenses.

Further, the imaging apparatus 100A according to the second embodiment can be used for the WFCO of a zoom lens designed considering small size, light weight, and cost in a digital camera, camcorder, or other consumer electronic device.

Further, in the second embodiment as well, since the apparatus has the imaging lens device 200 having the wavefront forming optical element for deforming the wavefront of the image formed on the light receiving surface of the imaging element 220 by the imaging lens 212 and the image processing device 300 for receiving the first order image FIM from the imaging lens device 200 and applying predetermined correction processing etc. to boost the MTF at the spatial frequency of the first order image and form the high definition final image FNLIM, there is the advantage that the acquisition of a high definition image quality becomes possible.

Further, the configuration of the optical system 210 of the imaging lens device 200 can be simplified, production becomes easy, and the cost can be reduced.

### Third Embodiment

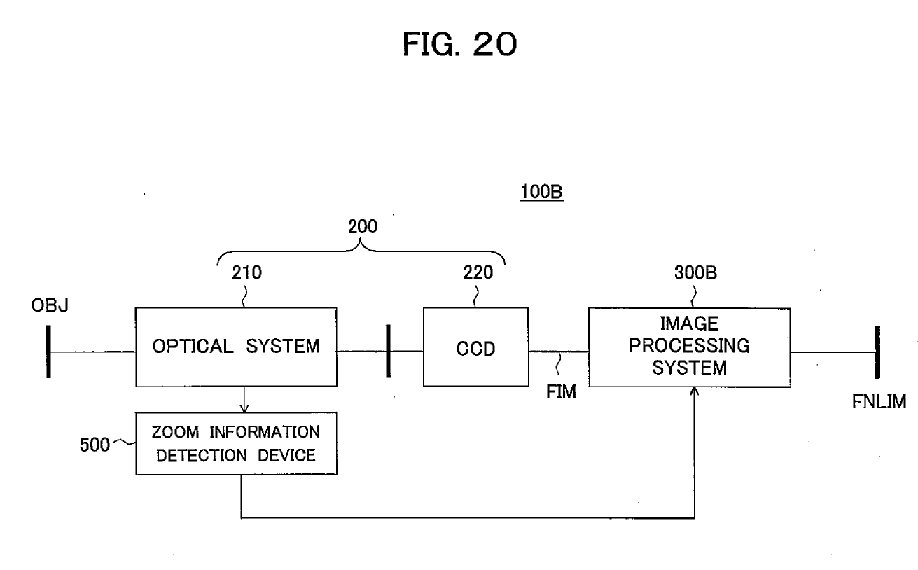

FIG. 20 is a block diagram showing the configuration of an imaging apparatus according to a third embodiment of the present invention.

The difference of an image apparatus 100B according to the third embodiment from the imaging apparatuses 100 and 100A of the first and second embodiments resides in the configuration providing a zoom information detection device 500 in place of the object schematic distance information detection device 400 and generating a dispersion-free image signal from dispersed image signal from the imaging element 220 based on the zoom position or zoom amount read out from the zoom information detection device 500.

The rest of the configuration is basically the same as those of the first and second embodiments.

Accordingly, the zoom optical system 210 has the same configuration as the configuration shown in FIG. 4.

Further, the image processing device 300B makes the means for restoring the regularly dispersed image to a focused image by the digital processing function as a “wavefront aberration control optical system (wavefront coding optical system (WFCO))”.

As explained before, in a general imaging apparatus, suitable convolution operation is not possible. An optical design eliminating the astigmatism, coma aberration, zoom chromatic aberration, and other aberration causing deviation of the spot image is required. However, optical design eliminating these aberrations increases the difficulty of the optical design and induces problems such as an increase of the number of design processes, an increase of the costs, and an increase in size of the lenses.

Therefore, in the present embodiment, as shown in FIG. 20, at the point of time when the imaging apparatus (camera) 100B enters into the imaging state, the zoom position or zoom amount thereof is read out from the zoom information detection device 500 and supplied to the image processing device 300B.

The image processing device 300B generates a dispersion-free image signal from a dispersed image signal from the imaging element 220 based on the zoom position or zoom amount read out from the zoom information detection device 500.

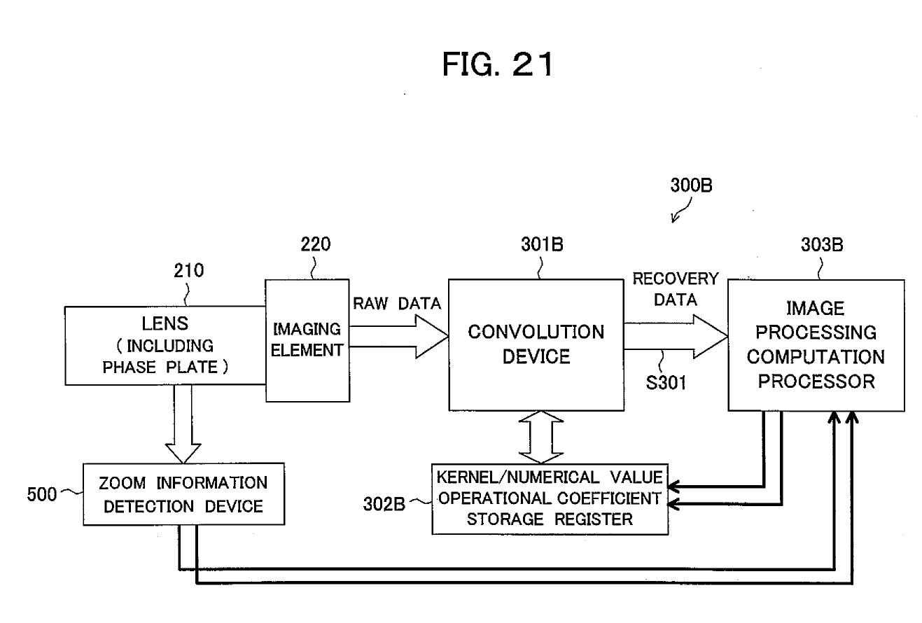

FIG. 21 is a block diagram showing an example of the configuration of the image processing device 300B generating a dispersion-free image signal from a dispersed image signal from the imaging element 220.

The image processing device 300B, as shown in FIG. 21, has a convolution device 301B, a kernel and/or numerical value operational coefficient storage register 302B, and an image processing computation processor 303B.

In this image processing device 300B, the image processing computation processor 303B obtaining information concerning the zoom position or zoom amount read out from the zoom information detection device 500 stores the kernel size and its operational coefficient used in suitable operation with respect to the zoom position in the kernel and/or numerical value operational coefficient storage register 302B and performs suitable operation at the convolution device 301A performing the operation by using those values so as to restore the image.

Here, the basic principle of the WFCO will be explained.

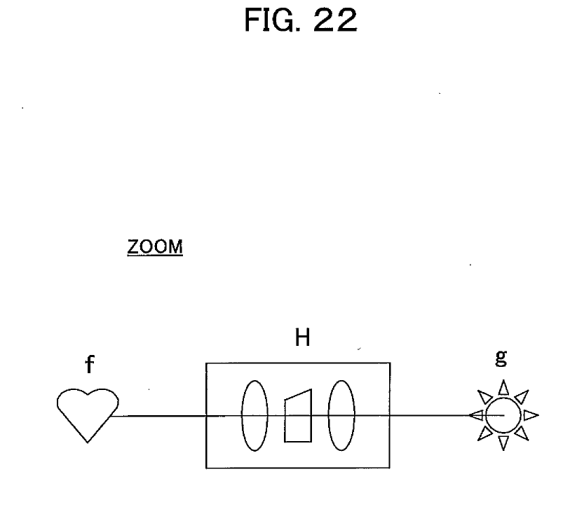

As shown in FIG. 22, by the image f of the object entering into the optical system H of the WFCO optical system H, the g image is generated.

This can be represented by the following equation:
g=H*f (Equation 8)
Here, the * represents convolution.

In order to find the object from the generated image, the following processing is required.
f=H⁻¹*g (Equation 9)

Here, the kernel size and operational coefficient concerning the function H will be explained.

The individual zoom positions are defined as Zpn, Zpn−1, . . . .

The H functions thereof are defined as Hn, Hn−1, . . . .

The spots are different, therefore the H functions become as follows.

$$Hn = ( \begin{matrix}a & b & c \\ d & e & f\end{matrix} ) \\ Hn - 1 = ( \begin{matrix}a′ & b′ & c′ \\ d′ & e′ & f′ \\ g′ & h′ & i′\end{matrix} ) \qquad [ Equation 10 ]$$

The difference of the number of rows and/or the number of columns of this matrix is referred to as the “kernel size”. The numbers are the operational coefficients.

As explained above, when using a phase plate as the optical wavefront modulation optical element in an imaging apparatus provided in a zoom optical system, the generated spot image differs according to the zoom position of the zoom optical system. For this reason, when performing the convolution operation of a focal point deviated image (spot image) obtained by the phase plate in a later DSP etc., in order to obtain the suitable focused image, convolution operation differing in accordance with the zoom position becomes necessary.

Therefore, the present embodiment is configured provided with the zoom information detection device 500, performing the suitable convolution operation in accordance with the zoom position, and obtaining the suitable focused image without regard as to the zoom position.

For suitable convolution operation in the image processing device 300B, it is possible to configure the system to commonly store one type of operational coefficient of convolution in the register 302B.

Other than this configuration, it is also possible to employ the following configurations.

It is possible to employ a configuration storing in advance a correction coefficient in the register 302B in accordance with each zoom position, correcting the operational coefficient by using this correction coefficient, and performing the suitable convolution operation by the corrected operational coefficient, a configuration storing in advance the kernel size and the operational coefficient per se of the convolution in the register 302B in accordance with each zoom position and performing the convolution operation by these stored kernel size and operational coefficient, a configuration storing in advance the operational coefficient in accordance with the zoom position as a function in the register 302B, finding the operational coefficient by this function according to the zoom position, and performing the convolution operation by the computed operational coefficient, and so on.

When linking this with the configuration of FIG. 21, the following configuration can be employed.

At least at least two conversion coefficients corresponding to aberrations caused by the phase plate 213a in accordance with the zoom position or zoom amount of the zoom optical system 210 shown in FIG. 4 are stored in advance in the register 302B as the conversion coefficient storing means. The image processing computation processor 303B functions as the coefficient selecting means for selecting the conversion coefficient in accordance with the zoom position or zoom amount of the zoom optical system 210 from the register 302B based on the information generated by the zoom information detection device 500 as the zoom information generating means.

Further, the convolution device 301B as the converting means converts the image signal according to the conversion coefficient selected at the image processing computation processor 303B as the coefficient selecting means.

Alternatively, as explained before, the image processing computation processor 303B as the conversion coefficient operation means processes the conversion coefficient based on the information generated by the zoom information detection device 500 as the zoom information generating means and stores the same in the register 302B.

Then, the convolution device 301B as the converting means converts the image signal according to the conversion coefficient obtained in the image processing computation processor 303B as the conversion coefficient operation means and stored in the register 302B.

Alternatively, at least one correction value in accordance with the zoom position or zoom amount of the zoom optical system 210 is stored in advance in the register 302B as the correction value storing means. This correction value includes the kernel size of the object aberration image.

The register 302B functioning also as the second conversion coefficient storing means stores in advance a conversion coefficient corresponding to the aberration due to the phase plate 213a.

Then, based on the zoom information generated by the zoom information detection device 500 as the zoom information generating means, the image processing computation processor 303B as the correction value selecting means selects the correction value in accordance with the zoom position or zoom amount from the register 302 as the correction value storing means.

The convolution device 301B as the converting means converts the image signal based on the conversion coefficient obtained from the register 302B as the second conversion coefficient storing means and the correction value selected by the image processing computation processor 303B as the correction value selecting means.

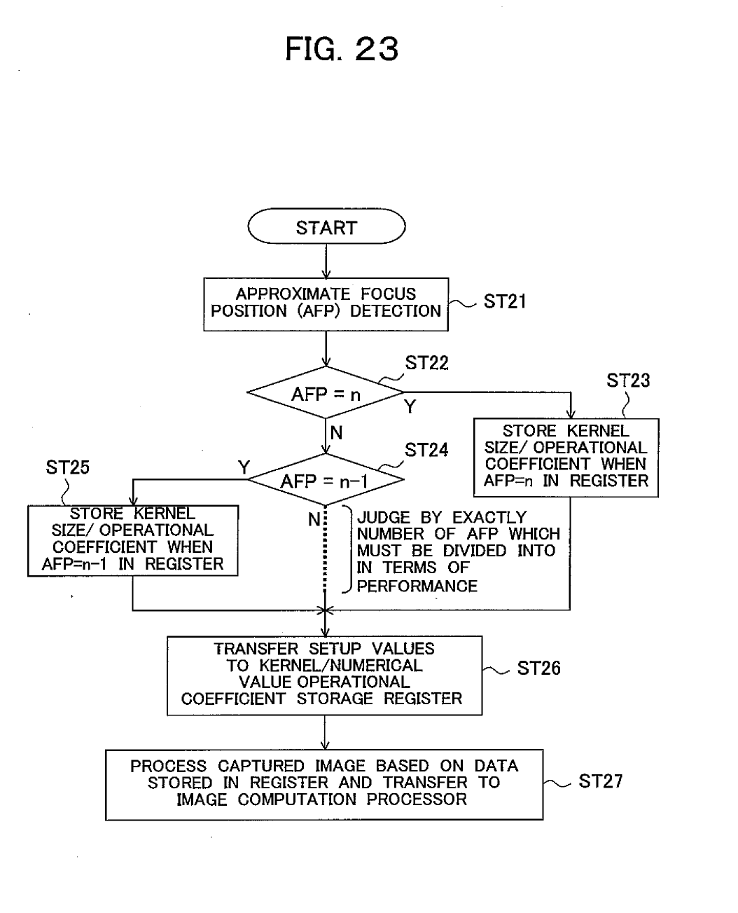

Next, the concrete processing in the case where the image processing computation processor 303B functions as a conversion coefficient operation means will be explained with reference to the flow chart of FIG. 23.

Along with the zoom operation of the zoom optical system 210, the zoom information detection device 500 detects the zoom position (ZP) and supplies the detected information to the image processing computation processor 303B (ST21).

The image processing computation processor 303B performs the judgment of whether or not the zoom position ZP is n (ST22).

When it is judged at step ST22 that the zoom position ZP is n, the kernel size where ZP=n and the operational coefficient are found and stored in the register (ST23).

When it is judged at step ST22 that the zoom position ZP is not n, the judgment of whether or not the zoom position ZP is n−1 is carried out (ST24).

When it is judged at step ST24 that the zoom position ZP is n−1, the kernel size where ZP=n−1 and the operational coefficient are found and stored in the register (ST25).

After this, the judgment processing of steps ST22 and ST24 is carried out for exactly the number of zoom positions ZP which must be divided into in terms of performance, and the kernel size and operational coefficients are stored in the register.

The image processing computation processor 303B transfers the set values to the kernel and/or numerical value operational coefficient storage register 302B (ST26).

Then, the image data captured at the imaging lens device 200 and input to the convolution device 301B is processed by convolution operation based on the data stored in the register 302B, and the processed and converted data S302 is transferred to the image processing computation processor 303B (ST27).

The third embodiment employs the WFCO and can obtain a high definition image quality. In addition, it is possible to simplify the optical system and possible to reduce the costs.

These characteristic features were explained in detail in the first embodiment, so the explanation thereof is omitted here.

As explained above, according to the third embodiment, since the apparatus has the imaging lens device 200 for capturing the dispersed image of an object passing through the zoom optical system, non-zoom optical system, and the phase plate (optical wavefront modulation element), the image processing device 300B for generating a dispersion-free image signal from a dispersed image signal from the imaging element 220, and the zoom information detection device 500 for generating the information corresponding to the zoom position or zoom amount of the zoom optical system and since the image processing device 300B generates a dispersion-free image signal from the dispersed image signal based on the information generated by the zoom information detection device 500, by making the kernel size used at the time of the convolution operation and the coefficients used in the numerical value operation thereof variable and linking the suitable kernel size by the zoom information of the zoom optical system 210 and the coefficients explained above, the lenses can be designed without regard as to the zoom position and the image can be restored by high precision convolution. Accordingly, there are the advantages that the provision of a focused image becomes possible without requiring optical lenses having a high difficulty, expensive cost, and large size and without driving the lenses.

Further, it is possible to use the imaging apparatus 103B according to the third embodiment in the WFCO of a zoom lens designed considering small size, light weight, and cost in a digital camera, camcorder, or other consumer electronic device.

Further, in the third embodiment, since the apparatus has the imaging-lens device 200 having the wavefront forming optical element for deforming the wavefront of the image formed on the light receiving surface of the imaging element 220 by the imaging lens 212 and the image processing device 300 applying the predetermined correction processing etc. for boosting the MTF in the spatial frequency of the first order image and forming the high definition final image FNLIM, there is the advantage that the acquisition of a high definition image quality becomes possible.

Further, the configuration of the optical system 210 of the imaging lens device 200 can be simplified, production becomes easy, and the cost can be reduced.

### Fourth Embodiment

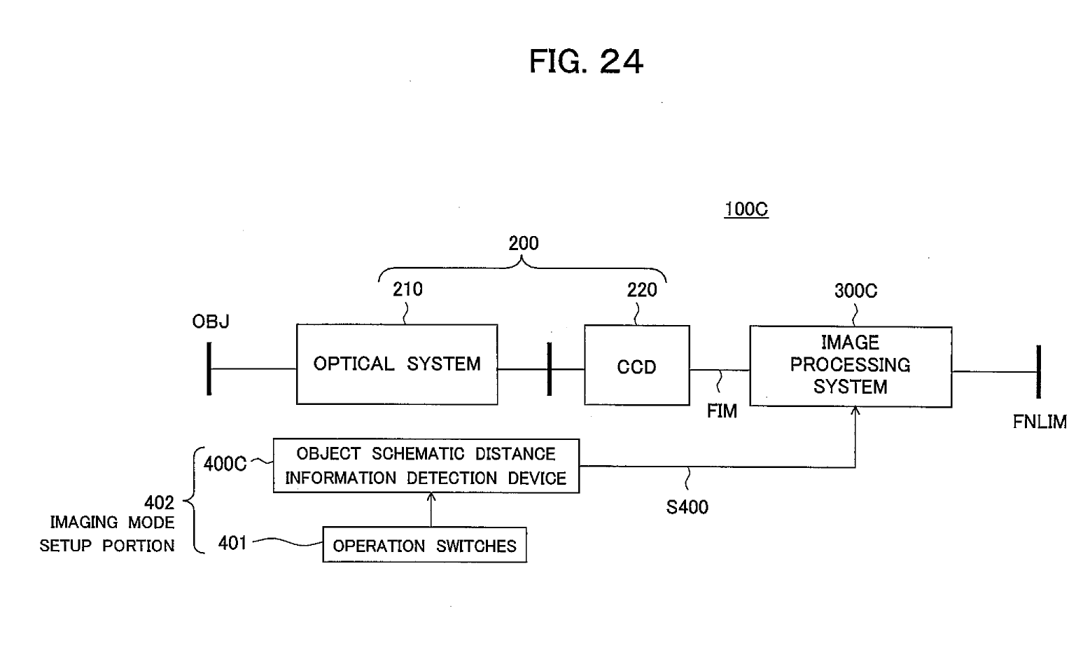

FIG. 24 is a block diagram showing the configuration of an imaging apparatus according to a fourth embodiment of the present invention.

The difference of an imaging apparatus 100C according to the fourth embodiment from the imaging apparatuses 100 and 100A of the first and second embodiments resides in the configuration forming an imaging mode setup portion 402 including operation switches 401 in addition to the object schematic distance information detection device 400C and generating a dispersion-free image signal from the dispersed image signal from the imaging element 220 based on the schematic distance information of the object distance of the object in accordance with the imaging mode.

The rest of the configuration is basically the same as those of the first and second embodiments.

Accordingly, the zoom optical system 210 has the same configuration as the configuration shown in FIG. 4.

Further, an image processing device 300C makes the means for restoring the regularly dispersed image to a focused image by the digital processing function as a “wavefront aberration control optical system (wavefront coding optical system (WFCO))”.

The imaging apparatus 100C of the fourth embodiment has a plurality of imaging modes, for example, a macro imaging mode (proximate) and the distant view imaging mode (infinitely distant) other than the normal imaging mode (portrait) and is configured so that these imaging modes can be selected and input by the operation switches 401 of the imaging mode setup portion 402.

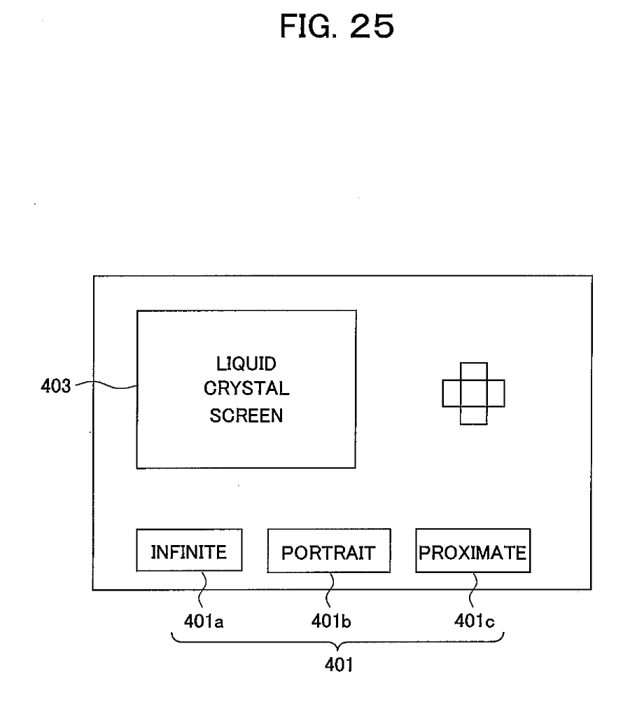

The operation switches 401 include for example selection switches 401a, 401b, and 401c provided on the bottom side of a liquid crystal screen 403 on the back surface of the camera (imaging apparatus) as shown in FIG. 25.

The selection switch 401a is a switch for selecting and inputting the distant view imaging mode (infinitely distant), the selection switch 401b is a switch for selecting and inputting the normal imaging mode (portrait), and the selection switch 401c is a switch for selecting and inputting the macro imaging mode (proximate).

Note that the switching method of the mode, other than the method using switches as in FIG. 25, may be a touch panel method, and the mode for switching the object distance from the menu screen may be selected.

The object schematic distance information detection device 400C as the object distance information generating means generates the information corresponding to the distance up to the object according to the input information of the operation switches and supplies the same as a signal S400 to the image processing device 300C.

The image processing device 300C performs processing for converting a dispersed image signal from the imaging element 220 of the imaging lens device 200 to a dispersion-free image signal. At this time, it receives the signal S400 from the object schematic distance information detection device 400C and performs different conversion processing in accordance with the set imaging mode.

For example, the image processing device 300C selectively executes normal conversion processing in the normal imaging mode, macro conversion processing corresponding to the macro imaging mode for reducing the aberration on the proximate side in comparison with this normal conversion processing, and distant view conversion processing corresponding to the distant view imaging mode for reducing the aberration on the distant side in comparison with the normal conversion processing in accordance with the imaging mode.

As explained before, in an optical system having a spot image differing according to the object position, in a general imaging apparatus, suitable convolution operation is not possible. An optical design eliminating the astigmatism, coma aberration, zoom chromatic aberration, and other aberration causing deviation of the spot image is required. However, optical design eliminating these aberrations increases the difficulty of the optical design and induces problems such as an increase of the number of design processes, an increase of the costs, and an increase in size of the lenses.

Further, when designing the optical system to correct astigmatism, coma aberration, spherical aberration, and other aberration inducing deviation of the spot image, if restoring the image, the image ends up becoming one focused over the entire screen. The picture-making required for application to a digital camera or camcorder etc., that is, a so-called “natural image” where the object desired to be captured is in focus, but the background is blurred cannot be realized.

Therefore, in the fourth embodiment, as shown in FIG. 24, at the point of time when the imaging apparatus (camera) 100 enters into the imaging state, the schematic distance of the object distance of the object in accordance with the imaging mode (the normal imaging mode, the distant view imaging mode, or the macro imaging mode in the case of the present embodiment) selected and input at the operation switches 401 is read out from the object schematic distance information detection device 400C as the signal S400 and supplied to the image processing device 300C.

The image processing device 300C, as explained before, generates a dispersion-free image signal from the dispersed image signal from the imaging element 220 based on the schematic distance information of the object distance of the object read out from the object schematic distance information detection device 400C.

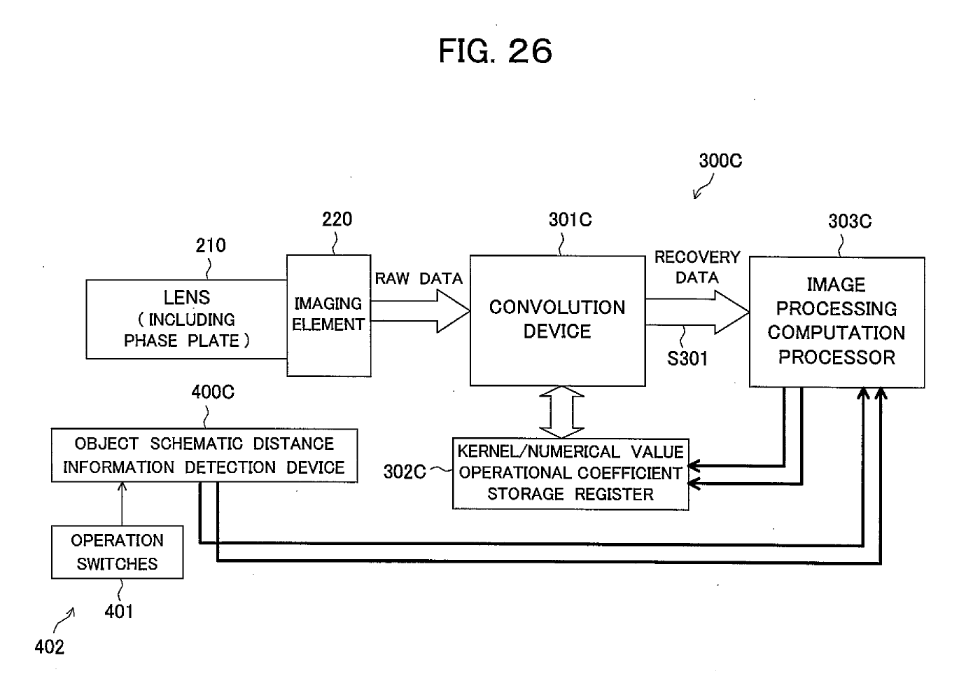

FIG. 26 is a block diagram showing an example of the configuration of the image processing device 300C generating a dispersion-free image signal from the dispersed image signal from the imaging element 220.

The image processing device 300C, as shown in FIG. 26, has a convolution device 301C, a kernel and/or operational coefficient storage register 302C as a storing means, and an image processing computation processor 303C.

In this image processing device 300C, the image processing computation processor 303C obtaining the information concerning the schematic distance of the object distance of the object read out from the object schematic distance information detection device 400C stores the kernel size and its operational coefficients used in the suitable operation with respect to the object distance position in the kernel and/or numerical value operation coefficient storage register 302C and performs the suitable operation at the convolution device 301C for performing operation using those values to restore the image.

Here, although there are overlapping portions, the basic principle of the WFCO will be explained.

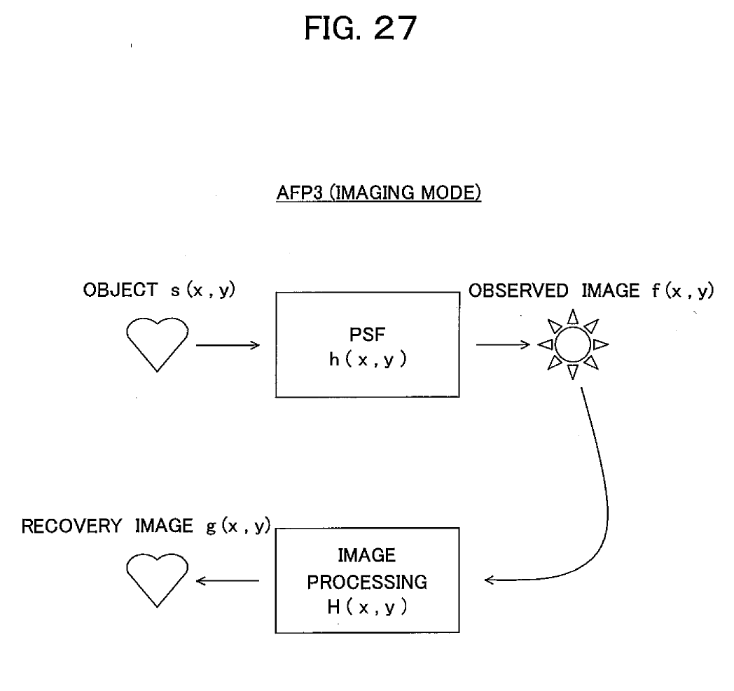

As shown in FIG. 27, when the measured object is s(x,y) and the weight function causing blurring in the measurement (point spread function PSF) is h(x,y), the measured observed image f(x,y) is represented by the following equation.
f(x,y)=s(x,y)*h(x,y) (Equation 11)
Note that * represents convolution.

The signal recovery at the WFCO finds s(x,y) from the observed image f(x,y). In order to perform the signal recovery, for example the original image s(x,y) is recovered by performing the following processing (multiplication) on f(x,y).
H(x,y)=h⁻¹(x,y) (Equation 12)

Namely, it can be represented as follows.
g(x,y)=f(x,y)*H(x,y)→s(x,y) (Equation 13)

Note that H(x,y) is not limited to the inverse filter as described above. Various types of filters for obtaining g(x,y) may be used.

Here, the kernel size and operational coefficients concerning H will be explained.

The object schematic distances are defined as FPn, FPn−1, . . . . Further, the H functions for the object schematic distances are defined as Hn, Hn−1, . . . . Each spot image differs according to the object distance. That is, the PSF used for generating the filter is different, therefore each H function differs according to the object distance.

Accordingly, the H functions become as follows.

$$Hn = ( \begin{matrix}a & b & c \\ d & e & f\end{matrix} ) \\ Hn - 1 = ( \begin{matrix}a′ & b′ & c′ \\ d′ & e′ & f′ \\ g′ & h′ & i′\end{matrix} ) \qquad [ Equation 14 ]$$

The difference of the number of rows and/or the number of columns of this matrix is referred to as the “kernel size”. The numbers are the operational coefficients.

Here, each H function may be stored in the memory. By using the PSF as a function of the object distance, using the object distance for calculation, and calculating the H function, it is also possible to set the system so as to create the optimum filter for any object distance. Further, it is also possible to use the H function as a function of the object distance and directly find the H function by the object distance.

As explained above, in the case of an imaging apparatus provided with a phase plate as an optical wavefront modulation element, if within a predetermined focal distance range, a suitable aberration-free image signal can be generated by image processing concerning that range, but if out of the predetermined focal length range, there is a limit to the correction of the image processing, therefore only an object out of the above range ends up becoming an image signal with aberration.

Further, on the other hand, by applying image processing not causing aberration within a predetermined narrow range, it also becomes possible to give blurriness to an the image out of the predetermined narrow range.

The present embodiment is configured to detect the distance up to the main object by the object schematic distance information detection device 400C including the distance detection sensor and perform processing for image correction differing in accordance with the detected distance.

The above image processing is carried out by convolution operation. In order to accomplish this, it is possible to employ a configuration commonly storing one type of operational coefficient of convolution operation, storing in advance a correction coefficient in accordance with the object distance, correcting the operational coefficient by using this correction coefficient, and performing the adaptive convolution operation with the corrected operational coefficient, a configuration storing in advance an operational coefficient in accordance with the object distance as a function, finding the operational coefficient by this function according to the focal length, and performing the convolution operation with the computed operational coefficient, and a configuration storing in advance the kernel size and the operational coefficient per se of convolution and performing the convolution operation by these stored kernel size and operational coefficient, and so on.

In the present embodiment, as explained above, the image processing is changed in accordance with the mode setting of the DSC (portrait, infinitely distant (scene), and macro).

When linking this with the configuration of FIG. 26, the following configuration can be employed.

As explained before, a conversion coefficient differing in accordance with each imaging mode set by the imaging mode setup portion 402 through the image processing computation processor 303C as the conversion coefficient operation means is stored in the register 302C as the conversion coefficient storing means.

The image processing computation processor 303C extracts the conversion coefficient from the register 302 as the conversion coefficient storing means based on the information generated by the object schematic distance information detection device 400C as the object distance information generating means in accordance with the imaging mode set by the operation switches 401 of the imaging mode setup portion 402. At this time, for example the image processing computation processor 303C functions as a conversion coefficient extracting means.

Further, the convolution device 301C as the converting means performs the conversion processing in accordance with the imaging mode of the image signal according to the conversion coefficient stored in the register 302C.

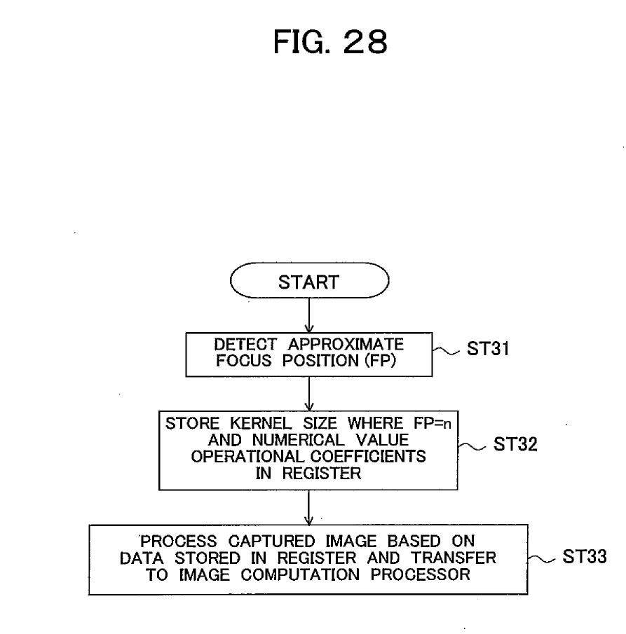

Next, the concrete processing in the case where the image processing computation processor 303C functions as the conversion coefficient operation means will be explained with reference to the flow chart of FIG. 28.

The object schematic distance information detection device 400C, in accordance with the imaging mode set by the operation switches 401 of the imaging mode setup portion 402, detects the approximate focus position (FP) by the object schematic distance information detection device 400C as the object distance information generating means and supplies the detected information to the image processing computation processor 303C (ST31).

The image processing computation processor 303C stores the kernel size and/or numerical value operational coefficient from the approximate focus position FP in the register 302C (ST32).

Then, the image data captured by the imaging lens device 200 and input to the convolution device 301C is processed by convolution operation based on the data stored in the register 302C, and the processed and converted data S302 is transferred to the image processing computation processor 303C (ST33).

The above image conversion processing basically includes an imaging mode setup step of setting up an imaging mode of the object to be captured, an imaging step of capturing a dispersed image of an object passing through at least an optical system and a phase plate at the imaging element, and a conversion step of generating a dispersion-free image signal from a dispersed image signal from the imaging element by using a conversion coefficient in accordance with the imaging mode set in the imaging mode setup step.

Note that the imaging mode setup step of setting up the imaging mode and the imaging step of capturing the dispersed image of an object at the imaging element may be either before or after the time of processing. Namely, the imaging mode setup mode may be before the imaging step, and the imaging mode setup step may be after the imaging step.

The present embodiment employs the WFCO and can obtain a high definition image quality. In addition, it is possible to simplify the optical system and possible to reduce the costs.

These characteristic features were explained in detail in the first embodiment, so the explanation thereof is omitted here.

As explained above, according to the fourth embodiment, since the apparatus has the imaging lens device 200 for capturing the object aberration image passing through the optical system and the phase plate (optical wavefront modulation element), the image processing device 300C for generating a dispersion-free image signal from a dispersed image signal from the imaging element 220, and the imaging mode setup portion 402 for setting up the imaging mode of the object to be captured and since the image processing device 300C performs conversion processing differing in accordance with the imaging mode set by the imaging mode setup portion 402, there are the advantages that the lenses can be designed without regard as to the object distance and defocus range and it becomes possible to restore the image by high precision convolution by making the kernel size used at the time of the convolution operation and the coefficients used in the numerical value operation thereof variable, determining the schematic distance of the object distance by the input of the operation switches etc., and linking the suitable kernel size in accordance with that object distance and the coefficients explained above.

Further, there are the advantages that a so-called natural image where the image to be captured is in focus, but the background is blurred can be obtained without requiring optical lenses having a high difficulty, expensive cost, and large size and without driving the lenses.

Further, the imaging apparatus 100C according to the fourth embodiment can be used for the WFCO of a zoom lens designed considering small size, light weight, and cost in a digital camera, camcorder, or other consumer electronic device.

Note that, in the fourth embodiment, the explanation was given by taking as an example the case where the macro imaging mode and the distant view imaging mode were provided other than the normal imaging mode as the imaging modes, but various aspects are possible. For example, either the macro imaging mode or the distant view imaging mode may be provided, or a further finer mode may be set.

Further, in the fourth embodiment as well, since the apparatus has with the imaging lens device 200 having the wavefront forming optical element for deforming the wavefront of the image formed on the light receiving surface of the imaging element 220 by the imaging lens 212 and the image processing device 300 for receiving the first order image FIM from the imaging lens device 200 and applying predetermined correction processing etc. to boost the MTF at the spatial frequency of the first order image and form the high definition final image FNLIM, there is the advantage that the acquisition of a high definition image quality becomes possible.

Further, the configuration of the optical system 210 of the imaging lens device 200 can be simplified, production becomes easy, and the cost can be reduced.

When using a CCD or CMOS sensor as the imaging element, there is a resolution limit determined from the pixel pitch. When the resolution of the optical system is over that limit resolution power, the phenomenon of aliasing is generated and exerts an adverse influence upon the final image. This is a known fact.

For the improvement of the image quality, desirably the contrast is raised as much as possible, but this requires a high performance lens system.

However, as explained above, when using a CCD or CMOS sensor as the imaging element, aliasing occurs.

At present, in order to avoid the occurrence of aliasing, the imaging lens system jointly uses a low pass filter made of a uniaxial crystalline system to thereby avoid the phenomenon of the aliasing.

The joint usage of the low pass filter in this way is correct in terms of principle, but the low pass filter per se is made of crystal, therefore is expensive and hard to manage. Further, there is the disadvantage that the optical system is more complicated due to the use in the optical system.

As described above, a higher definition image quality is demanded as a trend of the times. In order to form a high definition image, the optical system in a general imaging lens device must be made more complicated. If it is complicated, production becomes difficult. Also, the utilization of the expensive low pass filters leads to an increase in the cost.

However, according to the present embodiment, the occurrence of the phenomenon of aliasing can be avoided without using a low pass filter, and it becomes possible to obtain a high definition image quality

Note that, in the present embodiment, the example of arranging the wavefront forming optical element of the optical system 210 on the object side from the stop was shown, but functional effects the same as those described above can be obtained even by arranging the wavefront forming optical element at a position the same as the position of the stop or on the focus lens side from the stop.

Further, the lenses configuring the optical system 210 are not limited to the example of FIG. 4. In the present invention, various aspects are possible.

### INDUSTRIAL APPLICABILITY

The present imaging apparatus and imaging method and image conversion method enables lens design without regard as to the object distance and defocus range and enables image restoration by high precision operation, therefore can be applied to a digital still camera, a camera mounted in a mobile-phone, a camera mounted in a digital personal assistant, and so on.

1. An imaging apparatus comprising:
an imaging element for capturing a dispersed image of an object passing through at least an optical system and an optical wavefront modulation element, a converting means for generating a dispersion-free image signal from a dispersed image signal from the imaging element, and
an object distance information generating means for generating information corresponding to a distance up to the object, wherein
the converting means generates the dispersion-free image signal from the dispersed image signal based on the information generated by the object distance information generating means.

2. An imaging apparatus as set forth in claim 1, further comprising
a conversion coefficient storing means for storing in advance at least two conversion coefficients corresponding to the dispersion caused by at least the optical wavefront modulation element in accordance with the object distance and
a coefficient selecting means for selecting a conversion coefficient in accordance with a distance up to the object from the conversion coefficient storing means based on the information generated by the object distance information generating means, wherein
the converting means converts the image signal by the conversion coefficient selected by the coefficient selecting means.

3. An imaging apparatus as set forth in claim 1, further comprising
a conversion coefficient operation means for processing a conversion coefficient based on the information generated by the object distance information generating means, wherein
the converting means converts the image signal according to the conversion coefficient obtained from the conversion coefficient operation means.

4. An imaging apparatus as set forth in claim 3, wherein the conversion coefficient operation means includes a kernel size as a variable.

5. An imaging apparatus as set forth in claim 3, wherein
the apparatus has a storing means,
the conversion coefficient operation means stores the found conversion coefficient in the storing means, and
the converting means converts the image signal according to the conversion coefficient stored in the storing means to generate a dispersion-free image signal.

6. An imaging apparatus as set forth in claim 3, wherein the converting means performs convolution operation based on the conversion coefficient.

7. An imaging apparatus as set forth in claim 1, wherein
the optical system includes a zoom optical system,
the apparatus further comprises
a correction value storing means for storing in advance at least one correction value in accordance with a zoom position or zoom amount of the zoom optical system,
a second conversion coefficient storing means for storing in advance conversion coefficients corresponding to dispersion caused by at least the optical wavefront modulation optical element, and
a correction value selecting means for selecting a correction value in accordance with a distance up to the object from the correction value storing means based on the information generated by the object distance information generating means, and the converting means converts the image signal according to a conversion coefficient obtained from the second conversion coefficient storing means and the correction value selected from the correction value selecting means.

8. An imaging apparatus as set forth in claim 7, wherein the correction value stored in the correction value storing means includes the kernel size.

9. An imaging apparatus comprising:
an imaging element for capturing a dispersed image of an object passing through at least a zoom optical system, a non-zoom optical system, and an optical wavefront modulation element,
a converting means for generating a dispersion-free image signal from a dispersed image signal from the imaging element, and
a zoom information generating means for generating information corresponding to a zoom position or zoom amount of the zoom optical system, wherein
the converting means generates a dispersion-free image signal from the dispersed image signal based on the information generated by the zoom information generating means.

10. An imaging apparatus as set forth in claim 9, further comprising
a conversion coefficient storing means for storing in advance at least two conversion coefficients corresponding to the dispersion caused by at least the optical wavefront modulation element in accordance with the zoom position or zoom amount of the zoom optical system and
a coefficient selecting means for selecting a conversion coefficient in accordance with the zoom position or zoom amount of the zoom optical system from the conversion coefficient storing means based on the information generated by the zoom information generating means, wherein
the converting means converts the image signal according to the conversion coefficient selected at the coefficient selecting means.

11. An imaging apparatus as set forth in claim 9, further comprising
a conversion coefficient operation means for processing a conversion coefficient based on the information generated by the zoom information generating means, and
the converting means converts the image signal according to the conversion coefficient obtained from the conversion coefficient operation means.

12. An imaging apparatus as set forth in claim 9, further comprising
a correction value storing means for storing in advance at least one correction value in accordance with a zoom position or zoom amount of the zoom optical system,
a second conversion coefficient storing means for storing in advance conversion coefficients corresponding to the dispersion caused by at least the optical wavefront modulation element, and
a correction value selecting means for selecting a correction value in accordance with the zoom position or zoom amount of the zoom optical system from the correction value storing means based on the information generated by the zoom information generating means, and
the converting means converts the image signal according to the conversion coefficient obtained from the second conversion coefficient storing means and the correction value selected by the correction value selecting means.

13. An imaging apparatus as set forth in claim 12, wherein the correction value stored in the correction value storing means includes the kernel size.

14. An imaging apparatus comprising
an imaging element for capturing a dispersed image of an object passing through at least an optical system and an optical wavefront modulation element, a converting means for converting a dispersed image signal from the imaging element to a dispersion-free image signal, and
an imaging mode setting means for setting an imaging mode of the object to be captured, wherein
the converting means performs a different conversion processing in accordance with the imaging mode set by the imaging mode setting means.

15. An imaging apparatus as set forth in claim 14, wherein
the imaging mode includes a normal imaging mode and also at least one of a macro imaging mode or a distant view imaging mode,
when it includes the macro imaging mode, the converting means selectively executes normal conversion processing in the normal imaging mode and macro conversion processing for reducing dispersion at a proximate side in comparison with the normal conversion processing in accordance with the imaging mode, and
when it includes the distant view imaging mode, the converting means selectively executes normal conversion processing in the normal imaging mode and distant view conversion processing for reducing dispersion at a distant side in comparison with the normal conversion processing in accordance with the imaging mode.

16. An imaging apparatus as set forth in claim 14, further comprising
a conversion coefficient storing means for storing a different conversion coefficient in accordance with each imaging mode set by the imaging mode setting means and
a conversion coefficient extracting means for extracting a conversion coefficient from the conversion coefficient storing means in accordance with the imaging mode set by the imaging mode setting means, wherein
the converting means converts the image signal according to the conversion coefficient obtained from the conversion coefficient extracting means.

17. An imaging apparatus as set forth in claim 16, wherein the conversion coefficient storing means includes a kernel size as a conversion coefficient.

18. An imaging apparatus as set forth in claim 14, wherein
the imaging mode setting means includes
an operation switch for inputting the imaging mode and an object distance information generating means for generating information corresponding to a distance up to the object according to the input information of the operation switch, and
the converting means converts the dispersed image signal to a dispersion-free image signal based on the information generated by the object distance information generating means.

19. An imaging method comprising:
a step of capturing a dispersed image of an object passing through at least an optical system and an optical wavefront modulation element by an imaging element,
an object distance information generation step of generating information corresponding to a distance up to the object, and
a step of converting the dispersed image signal based on the information generated in the object distance information generation step and generating a dispersion-free image signal.

20. An imaging method comprising:
a step of capturing a dispersed image of an object passing through at least a zoom optical system, a non-zoom optical system, and an optical wavefront modulation element by an imaging element,
a zoom information generation step of generating information corresponding to the zoom position or zoom amount of the zoom optical system, and
a step of converting the dispersed image signal based on the information generated in the zoom information generation step and generating a dispersion-free image signal.

21. An image conversion method comprising:
an imaging mode setting step of setting an imaging mode of an object to be captured,
an imaging step of capturing a dispersed image of an object passing through at least an optical system and an optical wavefront modulation element by an imaging element, and
a conversion step of generating a dispersion-free image signal from a dispersed image signal from the imaging element by using a conversion coefficient in accordance with the imaging mode set in the imaging mode setting step.
